(19) United States
(12) Patent Application Publication
(10) Pub. No.: US 2004/0078542 A1
(43) Pub. Date: Apr. 22, 2004

(54) Systems and methods for transparent expansion and management of online electronic storage

(76) Inventors: William Tracy Fuller, Cupertino, CA (US); Alan Ray Nitteberg, Pleasanton, CA (US); Claudio Randal Serafini, Sunnyvale, CA (US)

Correspondence Address: William Tracy Fuller, 22165 Via Camino Ct., Cupertino, CA, 95014, US

(21) Appl. No.: 10/681,946

(22) Filed: Oct. 10, 2003

Related U.S. Application Data
(60) Provisional application No. 60/417,958, filed on Oct. 14, 2002.

(51) Int. Cl. G06F 12/00

(52) U.S. Cl. 711/172; 711/2

(57) ABSTRACT

An electronic storage expansion technique comprising a set of methods, systems and computer program products or processes that enable information appliances to transparently increase native storage capacities and share storage elements, and data, with other information appliances. The resulting environment is referred to as a Home Shared Object Architecture (HSOA). Information appliances are supplied with set a Storage Abstraction Layer (SAL) processes that enable the transparent attachment and utilization of additional Storage elements. Addition of these storage elements is utilized to transparently expand the capacity of the native drive elements. Added storage elements may be attached through the use of a home network; an external storage interface; or internal cables. Access to these resulting, logical storage elements (logical storage element reflecting the virtual drive configuration resulting from the combination of native drive and additional storage element) may, in turn, be shared amongst any HSOA enabled clients.

### CROSS-REFERENCE TO RELATED APPLICATIONS

60/417,958

### FEDERALLY SPONSORED RESEARCH

None

### SEQUENCE LISTING

None

### BACKGROUND OF THE INVENTION

1. Field of Invention

This invention relates to computing, or processing machine storage, specifically to an improved method to expand the capacity of native storage.

2. Background of the Invention

On-line storage usage in the home is growing, and growing rapidly. In fact the appetite for storage in the home is almost limitless. Applications and uses driving storage in the home are becoming widespread and include, but are not limited to games on the PC and game boxes for the TV, digital video capture and display devices (e.g. Digital Video Players and Recorders (DVR), Personal Video Recorders (PVR) (e.g. ReplayTV™and TiVo™), . . .), home answering machines, emerging home entertainment HUBS and centers, audio (MP3), digital cameras, Internet downloads (photos, video clips, etc) as well other general data stored on PCs.

The explosion in Digital Video and Image capture and distribution (through digital video recorders, or digital cameras) is creating a problem of particular note as much of the digital imagery data created and stored in the home today is fleeting due to data storage constraints. With film, pictures are taken, developed into photos, and then kept in an album (or a shoebox) for as long as you want, and with the negatives you can make more pictures at anytime in the future. If you need more storage space you simply buy another album or pair of shoes. On the other hand, Digital images (either still or motion) require large amounts of data storage capability. Once the capacity of the data storage device is consumed, it becomes necessary to either a) delete existing data or images to make space available for the new images or data, or, b) find a way to add or increase storage capacity. Either of which can be painful either from the loss of data or the associated challenges of increasing on-line storage capacity. Users require convenient, easily expandable and manageable on-line storage to retain all of these digital images.

In addition to the problem of limited storage resources, the disparate sources of digital data indicate the need for a common, central area for storage to enable sharing, and a consistent set of application interfaces and formats. Otherwise countless types of storage are required, with differing application interfaces and usage models adapted to the multitude of storage formats.

Finally, the solution must be local (with potential extensions to the Internet). For the private individual, the solution must be at home. In the case of a small office, or home office, the solution must be in the office. People want their data local where they have ready access, security, and control, not remotely with a Storage Service Provider (SSP). While this may change, currently, the SSP model does not provide the security that folks want (much of the data they save is private, and Storage Service Providers have not proven themselves yet).

The issues and concepts above indicate that there is a huge need for additional, easily expandable and sharable storage in the home. Yet, while the need exists there is no readily available technology that provides a solution. Today, system devices, or information appliances (e.g. a computer, a personal computer, an entertainment hub, a game box, a personal digital assistant, a data or information recorder, a data storage system, a data server, a digital camera, a household appliance, an automobile, a transportation device, a mobile telephone, a communications device, and combinations thereof) are shipped, and typically optimized for use with a single, internal storage element. As outlined above, this model is not sufficient to satisfy the growing needs of the current home or small business user. Current solutions to expand the available storage capacity encompass the following general forms:

(1) Resident solutions (i.e.—inside the home) Within the home environment there are four major expansion solutions.

(a) First add an additional storage element (disk) to the system—The main benefit of this approach is it mitigates the potentially challenging need to migrate the data and applications residing on the native storage device(s) to the larger device. The main drawback is increased management complexity of multiple storage elements/devices and the inability to share data with other systems. You have two choices here:

(i) Add an additional, internal storage device to your system, or information appliance. Typically this implies opening the system, which may or may not, violate the manufactures warranty. In those instances where you can add an internal device, it is a complex task better handled by an experienced technician and not the typical layperson. Once the additional storage device/element is successfully added to the system and is operating properly, the user must now manage the additional storage element as a separate and distinct logical and/or physical storage element from any of the original native storage element(s). Each time another physical storage element is added, the user must manage another element. As this number grows the management task becomes harder and more cumbersome. Once you've filled up your internal expansion capacity, or are not up to the challenges of adding internally based storage, you can move on to the next choice.

(ii) Instead of opening up your machine's chassis you can add an external, direct attached storage device. These are typically connected via, but not limited to, IDE, SCSI, USB, FireWire, Ethernet, or other direct or networked attached interface mechanisms. While mechanically simpler than adding an internal device not all systems or information appliances are setup to support external devices. Here again, as in (i) above, the management complexity of multiple storage elements grows as each new element is added.

(b) The second solution is to continually replace the native storage element (i.e. disk drive) with a larger disk drive. The primary advantage to this approach is once the data applications have been successfully migrated; only one storage element need be managed. The main drawback is the need to successfully migrate the data to the new storage element and any compatibility issues for both the BIOS and OS of the system to support the larger capacity storage elements, as well as the lack of data sharing capabilities. This can work in either the internal or external device solutions outlined above. The problems here are twofold:

(i) First, you have all the issues outlined under (1)(a)(i) (if you're replacing an internal storage device) or (1)(a)(ii) (if you're replacing an external storage device). While you can, continually, replace with bigger and bigger drives (and thus not hit a physical slot, address, or other mechanical limitation) you will, eventually, run into a technical limit with the compatibility of the newer technology within the older chassis.

(ii) Second, many users have more data than can be stored on even the largest of the commercially available home disk device products. This forces the user to buy more than one device and opens up all the problems already listed.

(c) The third solution, and typically the most costly and distasteful is to replace the entire system or information appliance with one that has more storage. While a simple upgrade, physically, you run into a major problem in migrating all of your data, replicating your application environment and, basically, returning to your previous computing status quo on the new platform.

(d) The fourth solution is to connect to some sort of network-attached home File Server (or Filer). This solution only works however if the system or information appliance is capable of accessing remote Filers. This solution is an elaboration of (1)(a)(ii). A simple home Filer can allow for greater degrees of expansion, as well as provide for the capability of sharing data with other systems. However, this solution is significantly more complex than the above solutions as you must now “mount” the additional storage, then “map” the drive into your system. As in the above solutions, you now have additional storage element/devices to manage as well as the added requirement to manage shared network environment. All of which adds ongoing complexity, particularly for the typical layperson.

(2) Non-Resident solutions (i.e.—outside the home)—The basic premise here is that you can utilize an Internet based storage solution with a 3^{rd} party Storage Service Provider. The first issue here is that you have no direct control over the availability of your data; you must rely upon the robustness of the Internet to ensure your access. In addition, performance will be an issue. Finally, costs are typically high.

In summary, the problems with the existing solutions (outlined above) are the following:

(1) Online storage Expansion is complex—Once the many issues and challenges have been overcome in simply adding either an additional storage element or replacing the existing element with a larger one, either internally or externally, a new set of problems arise in the management and utilization of the new storage configuration. None of which can guarantee a seamless, transparent upgrade path to add more storage capacity in the future.

(2) Expansion is limited—Unless you are adding an external Filer the solutions are limited in terms of the degree of expandability. Typically, no more than two disk storage devices can be housed in today's PC (some can manage up to four). Either cabling, addressing, or PCI slot limitations will also limit the number of external devices that can be added.

(3) Ongoing management is complex—Each additional drive, or mount point (for Filer attached drives) is treated as a separate storage element and must be configured, mounted and managed individually. In no case can you simply increase the size of your existing disk drive or element. This is true regardless of whether you are attempting to expand a primary, or native, drive (in this document the primary, or native drive, or storage element, implies that storage element required for basic operation of the processing or computing element; e.g. the “C” drive in Windows machines) or any other current attached and configured storage element. While you can concatenate, or stripe drives together, in some cases, to increase a drive's capacity, doing this to an existing drive can be complex, not recommended, or even not possible (as in the case of your boot device, which is usually, again, your existing primary, or native, drive). These more complex storage configurations (concatenations, mirrors, stripes) are also not available in today's Home Entertainment Hubs.

(4) Data migration—This is an issue if you are replacing a smaller device with a larger one, or replacing the entire unit or machine. Inaccurate migration of data and applications can result in loss of data and the improper function or failure of applications. Any or all of which can result in a catastrophic failure.

(5) Sharing is difficult or impossible—Unless you have a home network and are adding a home Filer you cannot share any of the storage you added. In addition, even home Filers are not able to share storage with non-PC type devices (e.g. Home Entertainment Hubs). There are emerging home Filers, but these units still must be configured on a network, setup and managed—again, beyond most user's capabilities and they don't address the storage demands of the emerging home entertainment systems. Trying to concatenate an internal drive with an external drive (i.e.—mounted from a Filer) is difficult, at best, and impossible in many instances.

While we have described, above, the various methods that can be used to add storage capacity to computing environments, there is currently no technology available that can be used to easily expand, consolidate, share and migrate data in such a manner that your existing storage element's capacity is transparently increased. Expansion of storage has been approached in a number of ways. A number of techniques have been employed to alter the way storage is perceived by a user or application.

U.S. Pat. No. 6,591,356 B2, named Cluster Buster, presents a mechanism to increase the storage utilization of a file system that relies on a fixed number of clusters per logical volume. The main premise of the Cluster Buster is that for a file system that uses a cluster (cluster being some number of physical disk sectors) as the minimum disk storage entity, and a fixed number of cluster addresses; a small logical disk is more efficient than a large logical disk for storing small amounts of data. (Allow small here to be enough data only to fill a physical disk sector.) An example of such a file system is the Windows FAT16 file system. This system uses 16 bits of addressing to store all possible cluster addresses. This implies a fixed number of cluster addresses are available. Thus, to store the same number of clusters on a “small” logical partition, versus a “very large” logical partition, the number of sectors within a cluster must be made larger for the “very large” logical partition. In such a case storing data that occupies one disk sector would waste storage space within the very large logical partition's cluster. To make use of large storage devices more efficient, the Cluster Buster divides a large storage device into a number of small logical partitions, thus each logical partition has a small (in terms of disk sectors) cluster size. However, to aide the user/application from dealing the potentially large number of logical volumes a mechanism is inserted between the file system and the user/application. This mechanism presents a number of “large” logical volumes to the user/application. The application intercepts requests to the file system and replaces the requested logical volume with the actual (i.e. on one of the many small) logical volumes.

In this system the smaller logical partitions are still initially created as standard logical volumes for the file system. In the Windows case, this would be the familiar alphabetic name; e.g. D:, E:, F:, G:, H:, etc. The Cluster Buster mechanism bundles together a number of the smaller logical volumes, and presents them as some logical volume. So, logical volumes D:, E:, F:, G:, and H: might be presented simply as the D: logical volume. The file systems still must recognize all of the created logical volumes, but the Cluster Buster mechanism takes care of determining the logical volume access requested of the file system.

The Cluster Buster mechanism is different from the current invention in that Cluster Buster is above the file system, and Cluster Buster requires that a number of logical volumes be created and each logical volume is directly accessible by the file system.

U.S. Pat. No. 6,216,202 B1 describes a computer system with a process and an attached storage system. The storage system contains a plurality of disk drives and associated controllers and provides a plurality of logical volumes. The logical volumes are combined, within the storage system, into a virtual volume(s), which is then presented to the processor along with information for the processor to deconstruct the virtual volume(s) into the plurality of logical volumes, as they exist within the storage system, for subsequent processor access. Additional application is presented to manage the multi-path connection between the processor and the storage system to address the plethora of connections constructed in an open systems, multi-path environment.

The current invention creates a “merged storage construct” that is perceived as an increase in size of a native storage element. The current invention provides no possible way of deconstruction of the merged storage construct for individual access to a member element. The merged storage construct is viewed simply as a native storage device by the processing element, a user or an application.

U.S. patent application 2002/0129216 A1 describes a mechanism to utilize “pockets” of storage in a distributed network setting as logical devices for use by a device on the network. The current invention can utilize storage that is already part a merged storage construct and is accessible in a geographically dispersed environment. Such dispersed storage is never identified as a “logical device” to any operating system, or file system component. All geographically dispersed storage becomes part of a merged storage construct associated specifically with some computer system somewhere on the geographically dispersed environment. That is to say, some computer's native drive becomes larger based on storage located some distance away, or to say in a different way, a part of some computer's merged storage construct is geographically distant.

Additionally, U.S. Pat. No. 6,366,988 B1, U.S. Pat. No. 6,356,915 B1, and U.S. Pat. No. 6,363,400 B1 describe mechanisms that utilize installable file systems, virtual file system drivers, or interception of API calls to the Operating System to provide logical volume creation and access. The manifestation of these mechanisms may be as a visual presentation to the user or to modify access by an application. These are different from the current invention in that the current invention does not create new logical volumes but does create a merged storage construct presenting a larger native storage element capacity, which is accessed utilizing standard native Operating System and native File Systems calls.

The current invention takes a different approach from the prior art. The fundamental concept of the current invention is: To abstract the underlying storage architecture in order to present a “normal” view. Here, “normal” simply means the view that the user or application would typically have of a native storage element. This is a key differentiator of the current invention from the prior art. The current invention selectively merges added storage with a native storage element to represent the abstracted merged storage, or merged storage construct, simply as a larger native storage element. The mechanism of the current invention does not register any added storage in the sense of creating an entity directly accessible by the operating system or the file system; no additional “logical volumes” viewable by the file system are created, nor is a component merged with the native storage element accessible except via normal accesses directed to the abstracted native storage element. Such accesses are made utilizing standard native Operating System and native File Systems calls.

The added storage is merged, with the native storage, at a point below the file system. The added storage, while increasing the native storage component is not required to be geographically co-located with the native storage element. Additionally, the merged storage elements themselves may be geographically dispersed.

### SUMMARY

In accordance with the present invention, an electronic storage expansion technique comprises a set of, methods, systems and computer program products or processes that enable information appliances (e.g. a computer, a personal computer, an entertainment hub/center, a game box, digital video recorder/personal video recorder, a personal digital assistant, a data or information recorder, a data storage system, a data server, a digital camera, a household appliance, an automobile, a transportation device, a mobile telephone, a communications device, and combinations thereof) to transparently increase their native storage capacities.

### DRAWINGS—FIGURES

In the drawings, closely related figures, and figure elements, have the same number but different alphabetic suffixes. The general instance of any element will have the numeric label only; a specific instance will add an alphabetic suffix character.

FIG. 1 shows the overall operating environment and elements at the most abstract level. All of the major elements are shown (including items not directly related to patentable elements, but pertinent to understanding of overall environment). It illustrates a simple home, or small office environment with multiple PCs and a Home Entertainment Hub.

FIG. 1a adds a home network view to the environment outlined in FIG. 1

FIG. 2 shows a myriad of, but not necessarily all encompassing set of, choices for adding storage to the environment outlined in FIG. 1 and FIG. 1a.

FIG. 2a shows a generic PC with internal drives and an external stand-alone storage device connected to the PC chassis.

FIG. 2b illustrates an environment consisting of a standard PC with External Storage subsystem interconnected through a home network

FIG. 3 illustrates the basic intelligent blocks, processes or means necessary to implement the preferred embodiment. It outlines the elements required in a client (Std PC Chassis or Hub) as well as an external intelligent storage subsystem.

FIG. 3a shows a single, generic PC Chassis with internal drives and an external stand-alone storage device connected to the disk interface.

FIG. 3b shows a single, generic PC Chassis with an internal drive and an External Storage Subsystem device connected via a network interface.

FIG. 3c shows multiple; standard PC Chassis along with a Home Entertainment Hub all directly connected an External Storage Subsystem.

FIG. 4 illustrates the Home Storage Object Architecture (HSOA) Storage Abstraction Layer (SAL) processes internal to a client provided with the methods and means required to implement the current invention

FIG. 4a illustrates the Home Storage Object Architecture (HSOA) Storage Abstraction Layer (SAL) processes internal to a client provided with the methods and means required to implement the shared client-attached storage device aspects of the current invention.

FIG. 4b illustrates the Home Storage Object Architecture (HSOA) Shared Storage Abstraction Layer (SSAL) processes internal to a client provided with the methods and means required to implement the shared data aspects of the current invention.

FIG. 4c illustrates the Home Storage Object Architecture (HSOA) Storage Abstraction Layer (SAL) processes internal to a client provided with the methods and means required to implement the shared data aspects of the current invention.

FIG. 5 illustrates the processes internal to an enabled intelligent External Storage Subsystem that is connected via a network interface.

FIG. 5a illustrates the processes internal to an enabled intelligent External Storage Subsystem that is connected via a disk interface.

FIG. 6 illustrates the output from the execution of a “Properties” command on a standard Windows 2000 attached disk drive prior to the addition of any storage.

FIG. 7 illustrates the output from the execution of a “Properties” command on a standard Windows 2000 attached disk drive subsequent to the addition of storage enabled by the methods and processes of this invention.

FIG. 8 illustrates the processes internal to a client provided with the, methods and means required to implement the shared data aspects of the current invention.

FIG. 8a illustrates an alternative set of processes and communication paths internal to a client provided with the methods and means required to implement the shared data aspects of the current invention.

FIG. 9 illustrates a logical partitioning of an external device or logical volume within an external storage subsystem.

### DETAILED DESCRIPTION

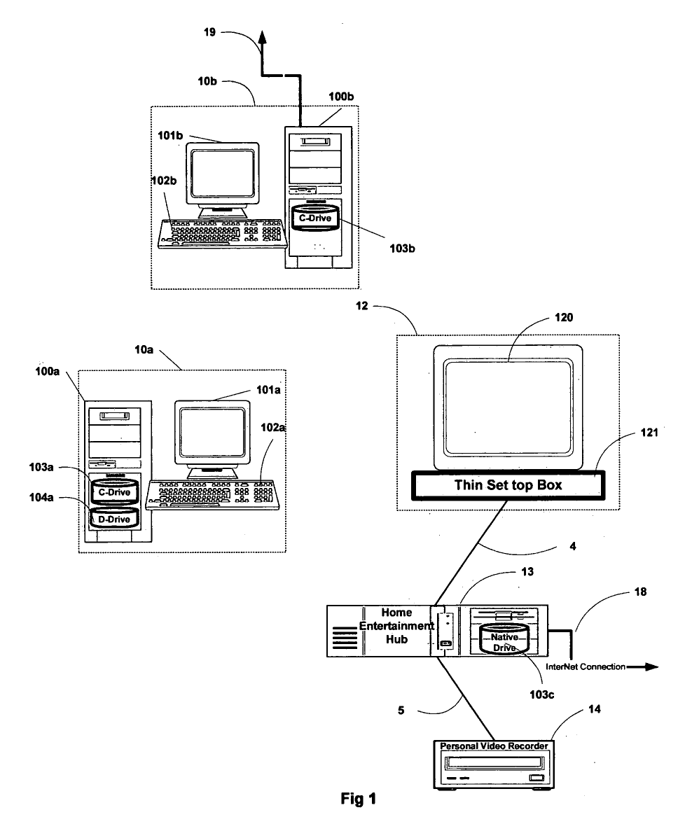

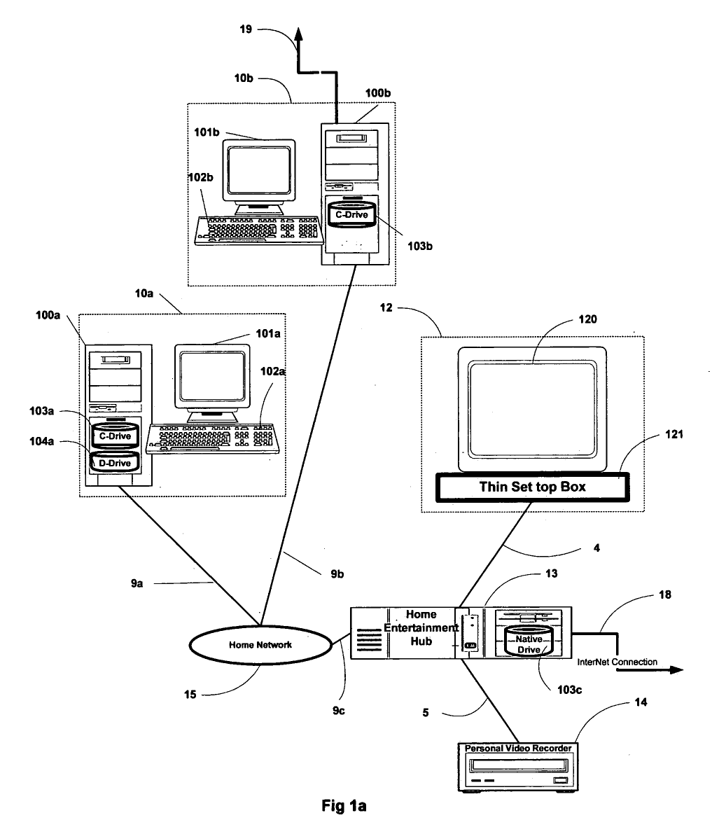

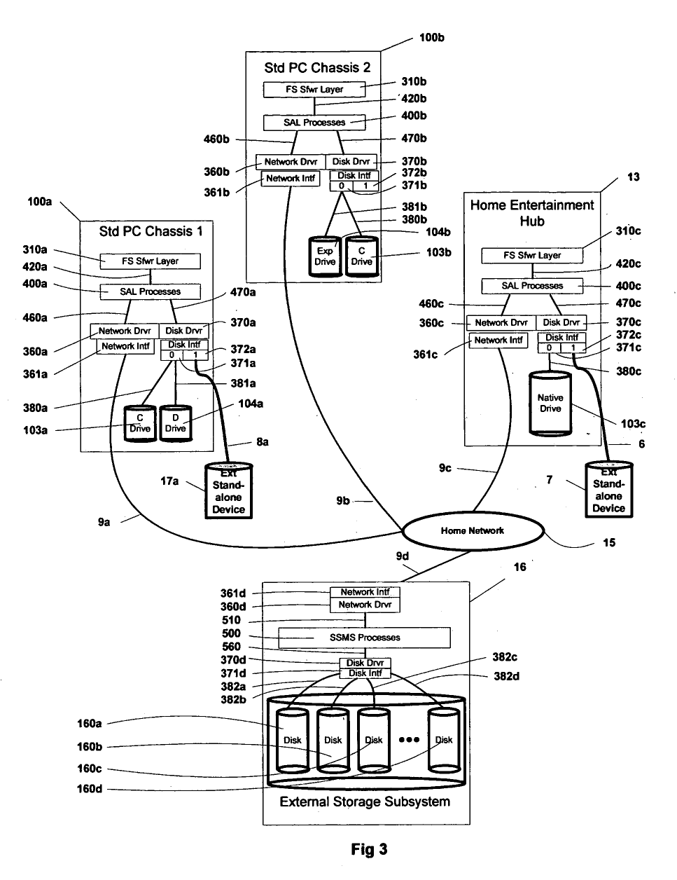

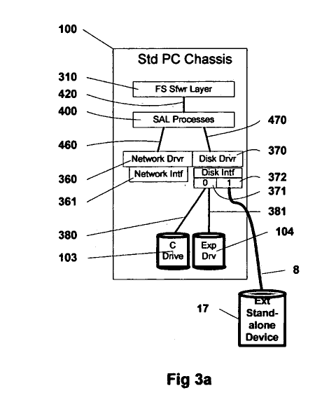

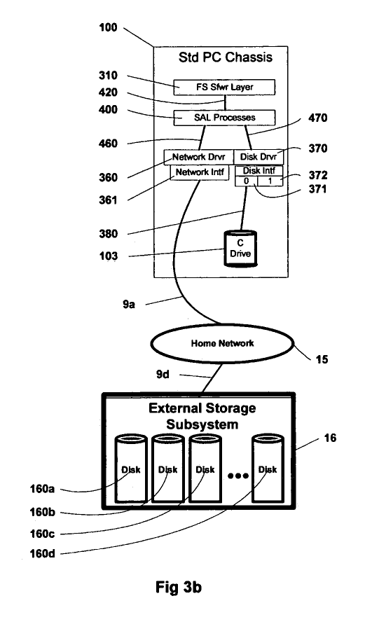

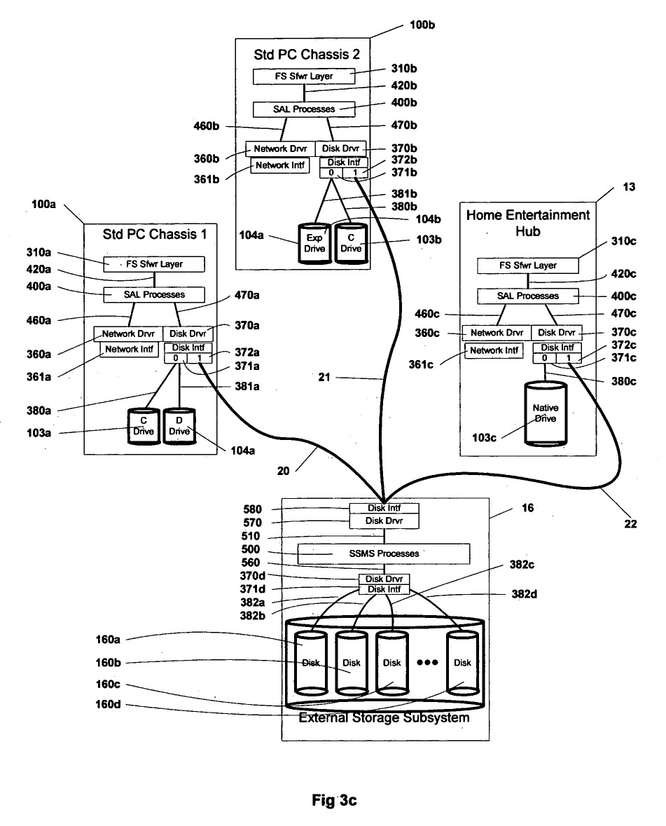

A preferred embodiment of the storage expansion of the present invention is illustrated in FIGS. 1, 2, 3, 4 and 5. These figures outline the, methods, systems and computer program products or processes claimed in this invention. FIG. 1 illustrates a computing, or processing, environment that could contain the invention. The environment may have one, or more, information appliances (e.g. personal computer systems 10a and 10b). Each said personal computer system 10a and 10b typically consists of a monitor element 101a and 101b, a keyboard 102a and 102b and a standard tower chassis, or desktop element 100a and 100b. Each said chassis element 100a and 100b typically contains the processing, or computing engines and software (refer to FIG. 3 for outline of software processes and means) and one, or more, native storage elements 103a, 104a and 103b. In addition to said personal computer systems 10a and 10b, the environment may contain a Home Entertainment Hub 13 (e.g. ReplayTV™ and TiVo™ devices). These said Hubs 13 are, typically, self-contained units with a single, internal native storage element 103c. Said Hubs 13 may, in turn, connect to various other media and entertainment devices. Connection to a video display device 12 via interconnect 4 or to a Personal Video Recorder 14, via interconnect 5 are two examples.

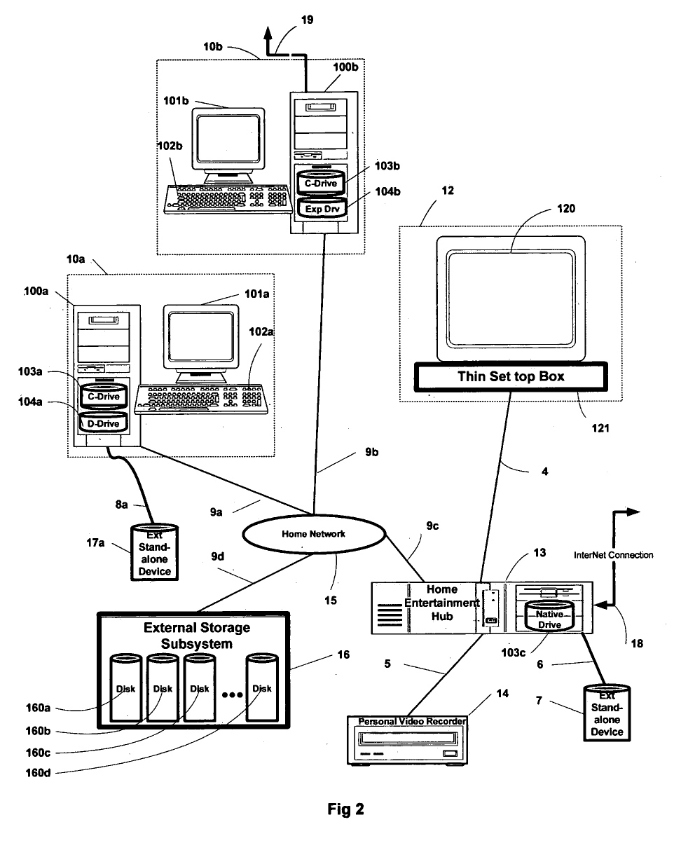

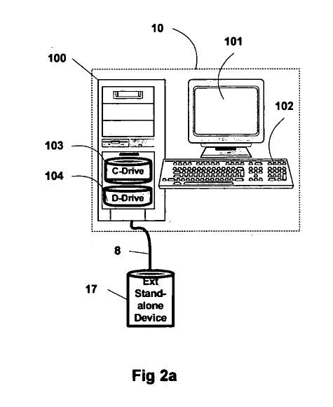

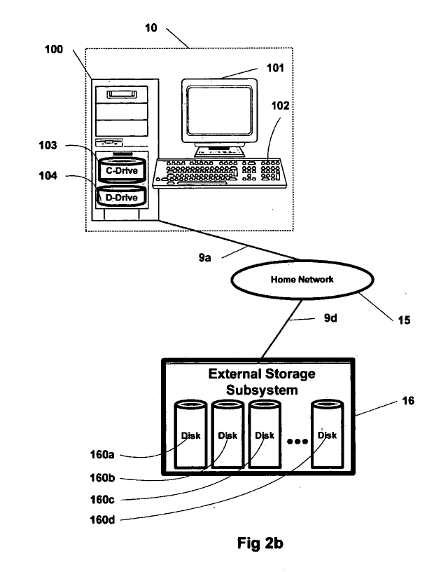

FIG. 2 illustrates possible methods of providing added storage capabilities to the environment outlined in FIG. 1. Said chassis element 100a or Hub 13 may be connected via an interface and cable 8a and 6 to external, stand-alone storage devices 17a and 7. Alternatively an additional expansion drive 104b may be installed in said chassis 10b. Additionally, a Home Network 15 may be connected 9a, 9b, 9c and 9d to said personal computers 10a and 10b as well as said Hub 13, and to an External Storage Subsystem 16. Connections 9a, 9b, 9c and 9d may be physical wire based connections, or wireless. While the preferred embodiment described here is specific to a home based network, the network may also be a local area network (LAN), metropolitan area network (MAN), wide area network (WAN) or any combination of these.

FIG. 3 illustrates the major internal processes and interfaces which make up the preferred embodiment of the current invention. Said chassis elements 100a and 100b as well as said Hub 13 contain a set of Storage Abstraction Layer (SAL) processes 400a, 400b and 400c. Said SAL processes 400a-400c utilize a connection mechanism 420a, 420b and 420c to interface with the appropriate File System 310a, 310b and 310c, or other OS interface. In addition, said SAL 400a-400c processes utilize a separate set of connection mechanisms

460a, 460b and 460c to interface to a network driver 360a, 360b and 360c, and

470a, 470b and 470c to interface to a disk driver 370a, 370b and 370c

The network driver, in turn, utilizes Network Interfaces 361a, 361b and 361c and interconnection 9a, 9b and 9c to connect to the Home Network 15. Said Home Network 15 connects via interconnection 9d to the External Storage Subsystem. The External Storage Subsystem may be a complex configuration of multiple drives and local intelligence, or it may be a simple single device element. Said disk driver 370a, 370b and 370c utilizes an internal disk interface 371a, 371b and 371c to connect 380a, 381a, 380b, 381b and 380c to said internal storage elements (native, or expansion) 103a, 103b, 103c, 104a, and 104b. Said Disk Driver 370a and 370c may utilize disk interface 372a, and 372c, and connections 8a and 6 to connect to the local, external stand-alone storage elements 17a and 7.

An External Storage Subsystem may consist of a standard network interface 361d and network driver 360d. Said network driver 360d has an interface 510 to Storage Subsystem Management Software (SSMS) processes 500 which, in turn have an interface 560 to a standard disk driver 370d and disk interface 371d. Said disk driver 370d and said disk interface 371d then connect, using cables 382a, 382b, 382c and 382d, to the disk drives 160a, 160b, 160c and 160d within said External Storage Subsystem 16.

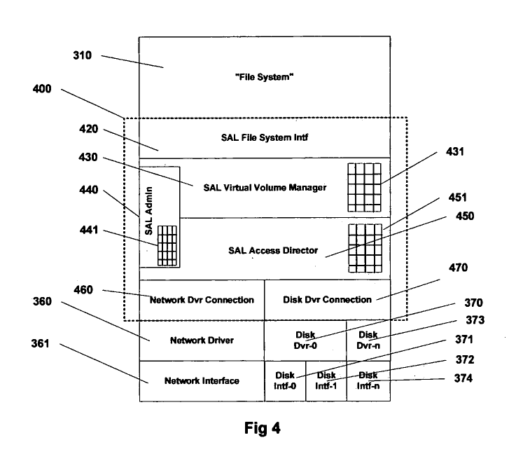

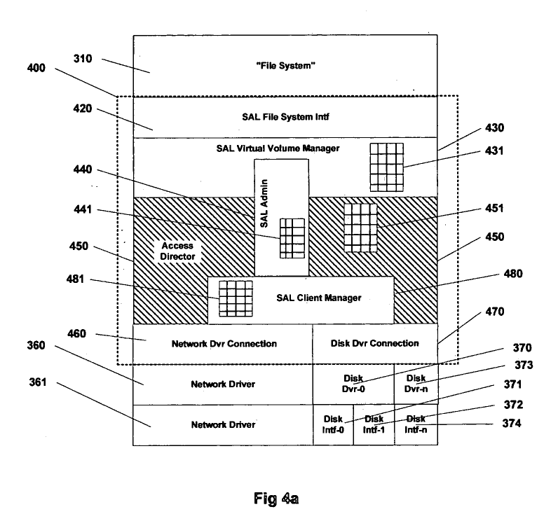

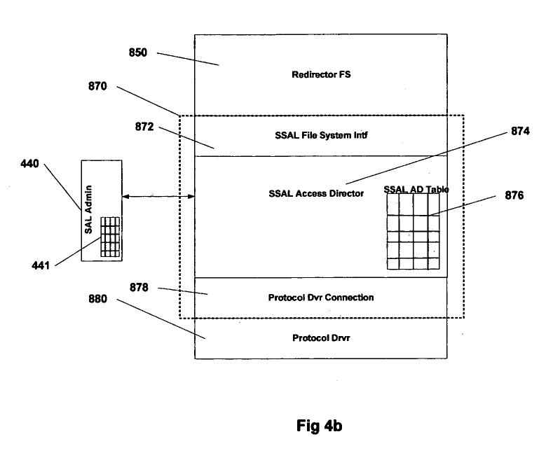

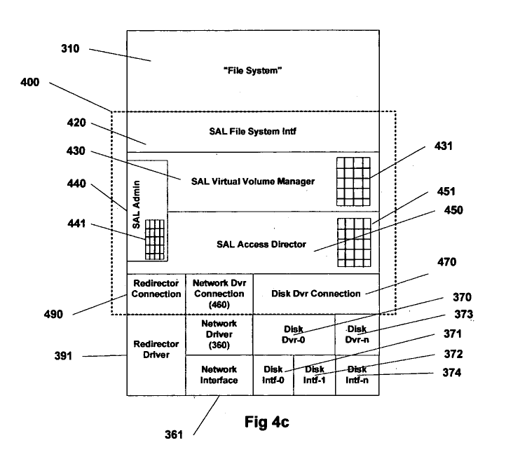

FIG. 4 illustrates the internal make up and interfaces of said SAL processes 400a, 400b, and 400c (FIG. 3). Said SAL processes 400a, 400b, and 400c (in FIG. 3), are represented in FIG. 4 by the generic SAL process 400. Said SAL process 400 consists of a SAL File System Interface means 420, which provides a connection mechanism between a standard File System 310 and a SAL Virtual Volume Manager means 430. A SAL Administration means 440 connects to and works in conjunction with both said Volume Manager 430 and an Access Director means 450. Said Access Director 450 connects to a Network Driver Connection means 460 and a Disk Driver Connection means 470. Said driver connection means 460 and 470 in turn appropriately connect to a Network Driver 360 or a Disk Driver 370, or 373.

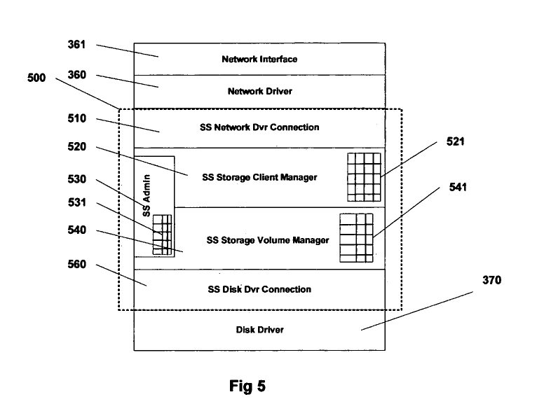

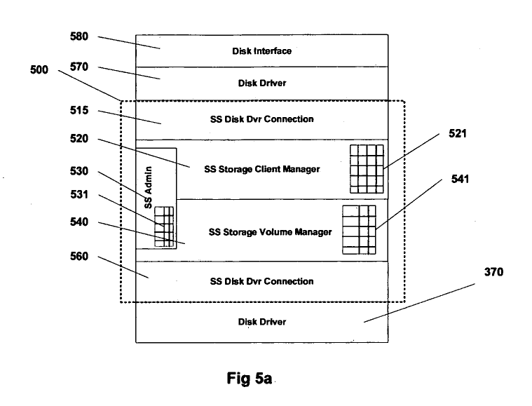

FIG. 5 illustrates the internal make up and interfaces of said SSMS processes 500. Said SSMS processes 500 consist of a Storage Subsystem Client Manager means 520, which utilizes said Storage Subsystem Driver Connection means 510 to interface to the standard Network Driver 360 and Network Interface 361. Said Storage Subsystem Client Manager means 520 in turn interfaces with a Storage Subsystem Volume Manager means 540. A Storage Subsystem Administrative means 530 connects to both said Client Manager 520 and said Volume Manager 540. Said Volume Manager 540 utilizes a Storage Subsystem Disk Driver Connection means 560 to interface to the standard Disk Driver 370.

Operation of Invention—Overview

In accordance with an embodiment of the present invention, methods, systems and computer program products or processes are provided for expansion, and management of storage.

So, what is needed to accomplish these lofty concepts? There are actually two elements that are necessary. The first is a set of processes, or means, that transparently facilitates the ability for information appliances, or clients to utilize additional storage devices. Information appliances, or clients (the terms information appliance and client are used interchangeably), in the context of this invention, are any processing, or computing devices (e.g. a computer, a personal computer, an entertainment hub, a game box, a personal digital assistant, a data or information recorder, a data storage system, a data server, a digital camera, a household appliance, an automobile, a transportation device, a mobile telephone, a communications device, and combinations thereof) with the ability to access storage. The second element is any additional storage. (Additional storage implies any electronic storage device other than a client's native, or boot storage device; e.g. in Windows-based PCs, the standard C-Drive). The combination of these processes and elements provide, for the home or small office, a virtual storage environment that can transparently expand any client's storage capacity.

This section will introduce the “Home Shared Object Architecture” (HSOA). While the term “Home” is used as a reference, the embodiment (or its alternatives) is not limited to a “Home” environment. Much of the following discussion will make use of the term an “HSOA enabled client”, or simply “client”, and implies any information appliance that has been imbued with the processes and methods of this invention.

The HSOA provides a basic storage expansion and virtualization architecture for use within a home network of information appliances. FIGS. 1, 1a and 2 are examples of a home environment (or small office). FIG. 1 illustrates an environment wherein various information appliances 10a, 10b and 13 may contain their own internal storage elements 103a, 104a, 103b and 103c (again, just one example, as many of today's entertainment appliances contain no internal storage). In FIG. 1, we see two types of information appliances. First, there is a Home Entertainment Hub (or just Hub) element 13. The Hub can be used to drive, or control many types of home entertainment devices (Televisions 120, Video Recorders 14, Set Top Box 121 (e.g. video game boxes), etc.) and may, or may not, have some form of Internet connectivity 18 (e.g. broadband interface, phone line, cable or satellite). Hubs 13 have, in general, very limited data storage (some newer appliances have disks). Second, there are home PC elements, or clients, 10a and 10b. These typically contain a keyboard 102a and 102b, a monitor 101a and 101b, and a chassis 100a and 100b, which contains a processing engine, various interfaces and the internal drives 103a, 104a and 103b. Again, you may, or may not have an external Internet connection 19 (broadband or phone line) into this environment, typically separate from the Hub 13 connectivity (even with a shared cable, the PC cable-modem is separate from the cable connections into your entertainment appliances). While FIG. 1 illustrates a stand-alone environment (none of the system elements are interconnected with each other), FIG. 1a shows a possible home network configuration. In this example a home network 15 is used with links 9a, 9b and 9c to interconnect intelligent system elements 10a, 10b and 13 together. This provides an environment wherein the intelligent system elements can communicate with one another (as mentioned previously this connectivity may be wire based, or wireless). While networked PCs can mount, or share (in some cases) external drives there is no common point of management. In addition, these network accessible drives cannot be used to expand the capacity of the native, internal drive. This is especially true when you add various consumer A/V electronics into the picture. Many other problems with storage expansion are outlined in the BACKGROUND OF THE INVENTION section. In FIG. 2 an external storage subsystem 16 is connected 9d into the home network 15. This is, today, fairly a typical of home computing environments and more likely to be found in small office environments. However, it does represent a basic start to storage expansion. Examples of external storage subsystems 16 are a simple Network Attached Storage (NAS) box, small File Server element (Filer), or an iSCSI storage subsystem. These allow clients to access, over a network (wireless, or wire based), the external storage element. A network capable file system (e.g., Network File System, NFS, or Common Internet File System, CIFS) are, today, required for accessing NAS boxes or filers, while iSCSI devices are accessed through more standard disk driver mechanisms. In addition, complex management, configuration and setup are required to utilize this form of storage. Again, other problems and issues with these environments have been outlined in the BACKGROUND OF THE INVENTION section above.

The basic premise for HSOA is an ability to share all the available storage capacities (regardless of the method of connectivity) amongst all information appliances, provide a central point of management and control, and allow transparent expansion of native storage devices. Each of these ideas is explained, independently, within the body of this patent.

Operation of Invention—Basic Storage Expansion

The fundamental concept of the current invention is: To abstract the underlying storage architecture in order to present a “normal” view. Here, “normal” simply means the view that the user or application would typically have of a native storage element. This is a key differentiator of the current invention from the prior art. The current invention selectively merges added storage with a native storage element to represent the abstracted merged storage, or merged storage construct, simply as a larger native storage element. The mechanism of the current invention does not register any added storage in the sense of creating an entity directly accessible by the operating system or the file system; no additional “logical volumes” viewable by the file system or the operating system are created, nor is a component merged with the native storage element accessible except via normal accesses directed to the abstracted native storage element. Such accesses are made utilizing standard native Operating System and native File Systems calls.

The added storage is merged, with the native storage, at a point below the file system. The added storage, while increasing the native storage component is not required to be geographically co-located with the native storage element. Additionally, the merged storage elements themselves may be geographically dispersed.

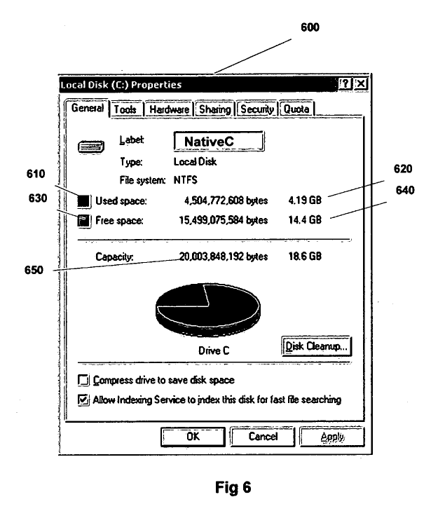

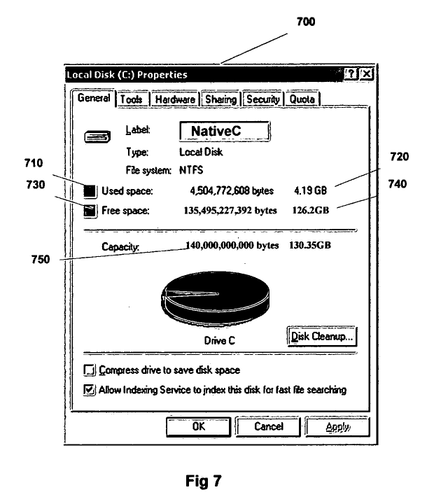

The basic, and underlying concept is an easy and transparent expansion of a client's native storage element. In a Windows PC environment this implies expanding the capacity of one of the internal disk drives (e.g. C-Drive). A simple environment for this is illustrated in FIG. 2a. In this figure an information appliance (e.g. a standard PC system element) 10 is shown with Chassis 100 and two native, internal storage elements 103 (C-Drive) and 104 (D-Drive). Additional storage in the form of an external, stand-alone disk drive 17 is attached (via cable 8) to said Chassis 100. The processes embodied in this invention allow the capacity of storage element 17 to merge with the capacity of the native C-Drive 103 such that the resulting capacity (as viewed by File System—FS, Operating System—OS, etc.) is the sum of both drives. This is illustrated in FIGS. 6 and 7. In FIG. 6 we see the typical output 600 of the Properties command on the native Windows boot, or C-Drive. Used space 610 is listed as 4.19 GB 620 (note, two capacity displays don't match exactly—listed bytes and GBs—as Windows takes some overhead for its own usage), while free space 630 is listed at 14.4 GB 640. This implies a disk of roughly 20 GB 650. If we then add (as an internal or external, stand-alone drive) a storage element with 120 GBs of capacity, and re-run the Properties command on the same, native Windows boot, or C-Drive we get the display as illustrated in FIG. 7. Used space 710 remains the same at 4.19 GB 720, while Free space 730 is listed at 126.2 GB 740, which is the combined capacity of the old free space and the entire new storage element (as all the new space is free). This implies a disk of roughly 140 GB 750. No special management operations have taken place that required user intervention (as would be required by other, current methods). No one had to mount the new storage element 17 and concatenate it with the C-Drive 103; no one had to even recognize that a new, separate drive existed. The FS and OS still view this as the standard, native internal C-Drive.

How is this accomplished? FIGS. 3a and 4 outline the basic software functions and processes employed to enable this expansion. FIG. 3a illustrates a Storage Abstraction (SAL) process 400, which resides within a standard system process stack. The SAL process, as illustrated in FIG. 4, consists of a File System Interface 420, which intercepts any storage access from the File System 310 and packages the eventual response. This process, in conjunction with a SAL Virtual Volume Manager 430 handles any OS, Application, File System or utility request for data, storage or volume information. The SAL Virtual Volume Manager process 430 creates the logical volume view as seen by upper layers of the system's process stack and works with the File System Interface 420 to respond to system requests. An Access Director 450 provides the intelligence required to direct accesses to any of the following (as examples):

1. an internal storage element (103 in FIG. 3a) through a Disk Driver Connection process 470, a Disk Driver-0 370, and a Disk Interface-0 371.

2. an External, Stand-alone Device (17 in FIG. 3a) through a Disk Driver Connection process 470, a Disk Driver-0 370, and a Disk Interface-1 372.

3. an External Storage Element (16 in FIG. 3) through a Network Driver Connection process 460, a Network Driver 360, and a Network Interface 361.

The SAL Administration process 440 (FIG. 4) is responsible for detecting the presence of added storage (see subsequent details) and generating a set of tables that the Access Director 450 utilizes to steer the IO, and that the Virtual Volume Manager 430 uses to generate responses. The Administration process 440 has the capability to automatically configure itself onto a network (utilizing a standard HAVi, or UPnP mechanism, for example), discover any storage pool(s) and help mask their recognition and use by an Operating System and its utilities, upload a directory structure for a shared pool, and set up internal structures (e.g. various mapping tables). The Administration process 440 also recognizes changes in the environment and may handle actions and responses to some of the associated platform utilities and commands.

The basic operation, using the functions outlined above, and the component relationships are as illustrated in FIG. 4. Upon boot the SAL Administrative process 440 determines that only the native drive (103 in FIG. 3a) is installed and configured (again, this is the initial configuration, prior to adding any new storage elements). It thus sets up, or updates, steering tables 451 in the Access Director 450 to recognize disk accesses and send them to the native storage element (e.g. Windows C-Drive). In addition, the Administrative process 440 configures, or sets up, logical volume tables 431 in the Virtual Volume Manager 430 to recognize a single, logical drive with the characteristics (size, volume label, etc.) of the native drive. In this way the SAL 400 passes storage requests onto the native storage element and correctly responds to other storage requests. Once a new drive has been added (17 in FIG. 3a, for example) the Administrative process 440 recognizes this fact (either through discovery on boot, or through normal Plug-and-Play type alerts) and takes action. First, the Administrative process 440 must query the new drive for its pertinent parameters and configuration information (size, type, volume label, location, etc.). This information is then kept in an administrative process' Drive Configuration table 441. Secondly, the Administrative process 440 updates the SAL Virtual Volume Manager's logical volume tables 431. These tables, one per logical volume, indicate overall size of the merged volume as well as any other specific logical volume characteristics. This allows the Virtual Volume Manager 430 to respond to various storage requests for read, write, open, size, usage, format, compression, etc. as if the system is talking to an actual, physical storage element. Thirdly, the Administrative process 440 must update the steering tables 451 in the Access Director 450. The steering tables 451 allow the Access Director 450 to translate the logical disk address (supplied by the File System 310 to the SAL Virtual Volume Manager 430 via the File System interface 420) into a physical disk address and send the request to an appropriate interface connection process (Network Drive Connection 460 or Disk Driver Connection 470 in FIG. 4). This allows the HSOA volume to be any combination of drive types, locations and connectivity methods. The Network Drive Connection 460 or Disk Driver Connection 470 processes, in turn, package requests in such a manner that a standard driver can be utilized (some form of Network Driver 360 or Disk Driver 370 or 373). For the Disk Driver 370 or 373, this can be a very simple interface and looks like a native File System interface to a storage, or disk driver. The Disk Driver Connection 470 must also understand which driver and connection to utilize. This information is supplied (as a parameter) in the Access Director's 450 command to the Disk Driver Connection process 470. In this example there may be one of three storage elements (103, 104, or 17 in FIG. 3a) that can be addressed. Each storage element may have its own driver and interface. In this example, if the actual data resides on the original, native storage element (C-Drive 103 in FIG. 3a) the Access Director 450 and Disk Driver Connection process 470 steer the access to Disk Driver-0 370 and Disk Interface-0 371. If the actual data resides on the internal, expansion storage element (Exp Drv 104 in FIG. 3a) the Access Director 450 and Disk Driver Connection process 470 may steer the access, again, to Disk Driver-0 370 and Disk Interface-0 371, or possibly another internal driver (if the storage element is of another variety than the native one). If the actual data resides on the external, stand-alone expansion Storage Element 17 (FIG. 3a) the Access Director 450 and Disk Driver Connection 470 may steer the access to Disk Driver-0 370 and Disk Interface-1 372. For the Network Driver 360 it's a bit more complicated. Remember, this is all happening below the File System and thus something like a Network File System (NFS) or a Common Internet File System (CIFS) are not appropriate. These add far too much overhead and require extensive system and user configuration and management.

Operation of Invention—Storage Expansion and Basic Storage Sharing

The second major aspect of this invention relates to the addition, and potential sharing amongst multiple users, of external intelligent storage subsystems. A simple use of a network attached storage device (as opposed to an external stand-alone storage device) is illustrated in FIG. 2b. This illustrates a single information appliance, or client element 10 connected 9a to a Home Network 15, which is, then connected 9d to an intelligent External Storage Subsystem 16. In this example the expansion is extremely similar to that described in the OPERATION OF INVENTION—BASIC STORAGE EXPANSION (above), with the exception that a network driver is utilized instead of a disk driver. The basic operation is illustrated in FIG. 3b and FIG. 4. FIG. 3b shows an environment wherein the External Storage Subsystem 16 is treated like a simple stand-alone device. No other clients, or users, are attached to the storage subsystem. Basic client software process relationships are illustrated in FIG. 4. Actions and operations above the connection processes (Network Driver Connection 460 and Disk Driver Connection 470) are described above (OPERATION OF INVENTION—BASIC STORAGE EXPANSION). In the case described here, the Access Director 450 interfaces with the Network Driver Connection 460. In addition to connecting to the appropriate Network Driver 360, the Network Driver Connection 460 provides a very thin encapsulation of the storage request that enables, among other things, transport of the request over an external, network link and the ability to recognize (as needed) which information appliance (e.g. PC, or Hub) sourced the original request to the external device.

The simple case, where a single External Storage Subsystem 16 is connected to a single client, is certainly workable, but not very interesting. Further, the details are encompassed within the more complex case outlined next. The power in this sort of environment (external, intelligent storage subsystems) is better represented in FIG. 2. In this figure multiple information appliance elements (PC Clients 10a and 10b as well as Home Entertainment Hub 13) are all connected 9a, 9b, and 9c into a Home Network 15, which in turn connects 9d to the External Storage Subsystem 16. In this case the External Storage Subsystem 16 is intelligent, and is capable of containing multiple disk drives 160a-160d. This environment provides the value of allowing each of the Clients 10a, 10b or Hub elements 13 to share the External Storage Subsystem 16. Share, in this instance, implies multiple users for the External storage resource, but not sharing of actual data. The methods described in this invention provide unique value in this environment. Wherein today's typical Filer must be explicitly managed (in addition to setting up the Filer itself, the drives must be mounted by the client file system, applications configured to utilize the new storage, and even data migrated to ease capacity issues on other drives), this invention outlines a transparent methodology to efficiently utilize all of the available storage across all enabled clients.

The basic, and underlying concept is still an easy and transparent expansion of a client's native storage element (e.g. C-Drive in a Windows PC). The OPERATION OF INVENTION—BASIC STORAGE EXPANSION section illustrated a single client's C-Drive expansion. The difference between this aspect of the invention and that described in the OPERATION OF INVENTION—BASIC STORAGE EXPANSION section is that the native storage element of each and every enabled Client 10a, 10b, or Hub 13 is transparently expanded, to the extent of the available storage in the External Storage Subsystem 16. If the total capacity of the External Storage Subsystem 16 is 400 GBytes, then every native drive (not just one single drive) of each enabled client 10a, 10b or Hub 13 appears to see an increase in capacity of 400 GBytes.

An alternative is to have each of the native storage elements of each and every enabled client 10a, 10b, or Hub 13 see a transparently expanded capacity equal to some portion of the total capacity of the External Storage Subsystem 16. This may be a desirable methodology in some applications. Regardless of the nature, or extent, of the native drive expansion, or the algorithm utilized in dispersing the added capacity amongst enabled clients, the other aspects of the invention remain similar.

All attached users share the entire available capacity of the External Storage Subsystem 16. Re-running the Properties command (or something similar) would result in each Client 10a, 10b, or Hub 13 seeing an increase of available storage space (again, along the lines of the example given in the OPERATION OF INVENTION—BASIC STORAGE EXPANSION section with FIGS. 6 and 7). This is extremely powerful. No requirement for a complex NFS or CIFS infrastructure (which makes it much easier for simpler elements like Hubs 13 to utilize the external storage), no deciding how to configure the storage subsystem, create multiple drives to be mounted on the individual clients, or perform complex administrative tasks to enable convoluted storage configurations on each Client 10a, 10b, Hub 13 or External Storage Subsystem 16. In addition, allowing each client user or hub user to share all of the external storage capacity allows much more effective capacity balancing and better utilization of the external storage.

All of this is accomplished with the methods and means outlined in this invention and illustrated in FIGS. 3, 4, 5 and 9. FIG. 3 provides a basic overview of the processes and interfaces involved in the overall sharing of an External Storage Subsystem 16. FIG. 4, which has been reviewed in previous discussions, illustrates the processes and interfaces specific to a Client 10a, 10b, Hub 13, while FIG. 5 illustrates the processes and interfaces specific to External Storage Subsystem 16. FIG. 3 is the basis for the bulk of this discussion, with references to FIGS. 4 and 5 called out when appropriate.

Note that for purposes of some brevity in the remaining discussion, no further distinction is made between a standard PC Client Element 10a and 10b (FIG. 1) and its associated Chassis 100a and 100b (FIGS. 1, 1a, 2, 3, 3c, or 9). Neither is a distinction made between a standard PC Client element 10a, 10b and an Entertainment Hub 13, both of which are “client users” of the External Storage Subsystem 16. The aggregate of a Client element 10a and 10b (or a Chassis 100a, 10b) and Hub 13 are referred to as information appliances, “HSOA enabled clients”, or simply “enabled clients”.

When an external, intelligent storage subsystem is added to a home network with HSOA enabled clients, the SAL Administration process (440 in FIG. 4) of each HSOA enabled client is informed of the additional storage by the system processes. An integral part of this discovery is the ability of the SAL Administration process (440 in FIG. 4) to mask drive recognition and usage by the native Operating System (OS), applications, the user, and any other low level utilities. One possible method of handling this (in Windows based systems) is through the use of a filter driver, or a function of a filter driver, that prevents the attachment from being used by the OS. This filter driver is called when the PnP (Plug and Play) system sees the drive come on line, and goes out to find the driver (with the filter drivers in the stack). While it may not be possible to mask any recognition of the new device by the system, the filter driver does not report the device to be in service as a “regular” disk with drive designation. This implies that a logical volume drive letter is not in the symbolic link table to point to the device and thus is not, available to applications and does not appear in any properties information or display. Furthermore, no sort of mount point is created for this now unnamed storage element, so the user has no accessibility to this storage.

Each HSOA enabled client has its logical volume table (431 in FIG. 4), its steering table (451 in FIG. 4) and its drive configuration table (441 in FIG. 4) updated to reflect the addition of the new storage. Each SAL Administration (440 in FIG. 4) may well configure the additional storage differently for its HSOA enabled client and SAL processes (400 in FIG. 4). This may be due to differing size, or number of currently configured drives or differing usage. The simplest mechanism is to add the new storage as a logical extension of the current storage, and thus any references to storage addresses past the physical end of the current drive are directed to the additional storage. For example, this results in the following. If, prior to addition of the new storage, Client PC Chassis 100a consists of C-Drive 103a with capacity of 15 GBytes and D-Drive 104a with capacity of 20 GBytes; Client PC Chassis 100b consists of C-Drive 103b with capacity of 30 GBytes; and Hub 13 consists of native drive 103c with capacity of 60 GBytes then the addition of External Storage Subsystem 16 with a capacity of 400 GBytes results in the following:

(1) The File System 310a in Chassis 100a sees C-Drive 103a having a capacity of 15+400, or 415 GBytes;

(2) The File System 310a in Chassis 100a sees D-Drive 104a having a capacity of 20+400, or 420 GBytes;

(3) The File System 310b in Chassis 100b sees C-Drive 103b having a capacity of 30+400, or 430 GBytes; and

(4) The File System 310c in Hub 13 sees a native drive 103c having a capacity of 60+400, or 460 GBytes

In the example above we added a TOTAL of 400 GBytes of extra capacity. While each of the HSOA enabled clients can utilize this added capacity, and each of the attached clients new, logical drives appear to grow by the entire 400 GBytes they cannot each, in truth, utilize all 400 GBytes. To do so would imply that we are storing an equivalent of

415+420+430+460=1725 GBytes, or 1.725 TBytes

This is clearly more capacity than was added. In actuality the added capacity is spread across all of the native drives in the environment enabled by the methods described in this invention. This method of capacity distribution is clearly not the only possible. There are other algorithms (e.g., a certain portion of the overall added capacity could be assigned to each native drive—not the entire amount) that could be used but they are immaterial to the nature of this invention.

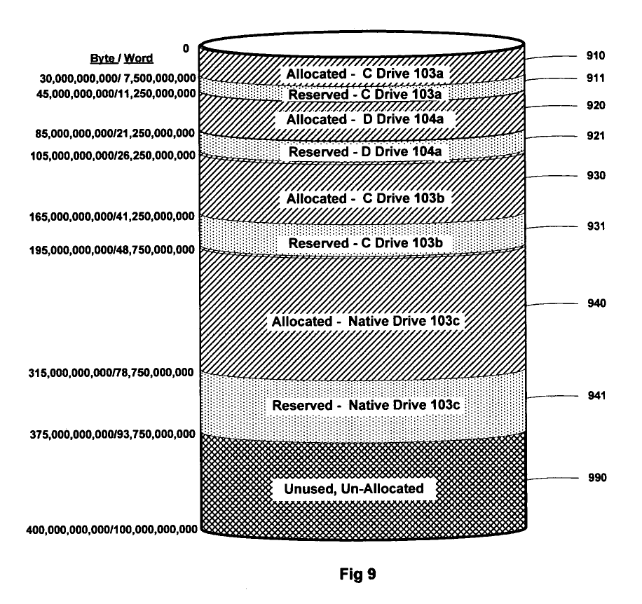

The SAL processes (400a, 400b and 400c) create these logical drives, or storage objects, but the actual usage of the External Storage Subsystem 16 is managed by the SSMS processes 500 (FIG. 5). As part of the discovery and initial configuration process the SAL Administration process (440 in FIG. 4) communicates with the SS Administration process (530 in FIG. 5). Part of this communication is to negotiate for the initial storage partitioning. As illustrated in FIG. 9 each attached, HSOA enabled client is allocated some initial space (e.g., double space of native drive)

1. Drive element 103a (Chassis 100a C-Drive) is allocated 30 GBytes 910

2. Drive element 104a (Chassis 100a D-Drive) is allocated 40 GBytes 920

3. Drive element 103b (Chassis 100b C-Drive) is allocated 60 GBytes 930

4. Drive element 103c (Hub 13 Native-Drive) is allocated 120 GBytes 940 and some reserved space (typically, 50% of the allocated space)

1. Drive element 103a (Chassis 100a C-Drive) is reserved an additional 15 GBytes

2. Drive element 104a (Chassis 100a D-Drive) is reserved an additional 20 GBytes

3. Drive element 103b (Chassis 100b C-Drive) is reserved an additional 30 GBytes

4. Drive element 103c (Hub 13 Native-Drive) is reserved an additional 60 GBytes

by the SS Administration process (530 in FIG. 5). Again, this allocation is only an example. Many alternative allocations are possible and fully supported by this invention. At a very generic level (not using actual storage block addressing) this results in the following for client 100a in FIG. 3. The Virual Volume manager (430 in FIG. 4) has two logical volume tables (431 in FIG. 4), Logical-C and Logical-D, representing the two logical volumes. The Access Director (450 in FIG. 4) has two steering tables (451 in FIG. 4) configured as shown in Tables I and II.

TABLE I
Steering Table - Logical C-Drive

| Logical Address Range | | | Actual/Physical | |
|---|---|---|---|---|
| (word = 4 bytes) | Drive | Interface | Drive Address | Notes/Actions |
| 1-3,750,000,000 | C | Disk0 | 1-3,750,000,000 | Access Native Drive |
| 3,750,000,001-12,500,000,000 | Ext SS | Network | 1-7,500,000,000 | Access External Storage Subsystem |
| 12,500,000,001-15,000,000,000 | Ext SS | Network | 7,500,000,001-11,250,000,000 | Using up the reserved area, have |
| | | | | Administration process increase |
| | | | | reserve space |
| 15,000,000,001-max address | NA | NA | ERROR | Error, has to be handled as an out |
| | | | | of bounds condition |

TABLE II
Steering Table - Logical D-Drive

| Logical Address Range | | | Actual/Physical | |
|---|---|---|---|---|
| (Word = 4 bytes) | Drive | Interface | Drive Address | Notes/Actions |
| 1-5,000,000,000 | D | Disk0 | 1-5,000,000,000 | Access Native Drive |
| 5,000,000,001-15,000,000,000 | Ext SS | Network | 11,250,000,001-21,250,000,000 | Access External Storage |
| | | | | Subsystem |
| 15,000,000,001-20,000,000,000 | Ext SS | Network | 21,250,000,001-26,250,000,000 | Using up the reserved area, |
| | | | | have Administration process |
| | | | | increase reserve space |
| 20,000,000,001-max address | NA | NA | ERROR | Error, has to be handled as an |
| | | | | out of bounds condition |

Once the basic tables are set up, HSOA enabled client operations proceed in a manner similar to that described previously. The SAL File System Interface process (420 in FIG. 4) intercepts all storage element requests. These pass on to the SAL Virtual Volume Manager process (430 in FIG. 4) that, through use if its logical volume tables, either responds to the request directly (a volume size query, for example) or passes the request on to the Access Director process (450 in FIG. 4). Requests that pass on to the Access Director 450 imply that the actual device is accessed (typically a read or a write). The Access Director 450, through use of its steering tables (451 in FIG. 4), dissects the logical volume request and determines which physical volume to address and what block address to utilize.

In the case in hand (the environment illustrated in FIG. 3 with the External Storage Subsystem 16, encompassing an additional 400 GBytes of storage capacity, configured as an extension to the internal disk drives 103a, 103b, 103c, and 104a, as outlined above), assume that the client represented by PC chassis 100a is accessing its logical C-drive at address 6,000,000,000 (word address, with a word consisting of 4 bytes). In an actual environment addressing methodologies can vary, these addresses are simply used to convey the mechanisms and processes involved. The SAL Virtual Volume Manager process (430 in FIG. 4) determines that this is a read/write operation for its logical C-drive. This is passed along to the Access Director (450 in FIG. 4). The Access Director 450 utilizes its steering table (451 in FIG. 4, and Table I above) to determine how to handle the request. The logical disk address is used as an index entry into the table (e.g. using the Logical Address Range column in Table I). This will then indicate that the External Storage Subsystem 16 must be accessed, using the Network Driver (360 in FIG. 4). The table indicates the appropriate driver, if more than one exists, and the adjusted address. In this case a local address 6,000,000,000 maps to remote address of 2,250,000,000. Once this determination is made, the Access Director 450 passes the request to the appropriate connection process, in this case the Network Connection process (460 in FIG. 4). The connection process then appropriately packages, or encapsulates the request such that it passes to the correct standard Network Driver (360 in FIG. 4) that, in turn, accesses the device. In this case the device is an intelligent External Storage Subsystem 16 with processes and interfaces illustrated in FIG. 5. The HSOA enabled client request is picked up by the External Storage Subsystem's 16 Network Interface 361 and Network Driver 360. These are similar (if not identical) to those of a client system. A Storage Subsystem (SS) Network Driver Connection 510 provides an interface between the standard Network Driver 360 and a SS Storage Client Manager 520. The SS Network Driver Connection process 510 is, in part, a mirror image of an enabled client's Network Driver connection process (460 in FIG. 4). It knows how to pull apart the network packet to extract the storage request, as well as how to encapsulate responses, or requests, back to an enabled client. In this example the SS Network Driver Connection 510 extracts the read/write request to address 2,250,000,000 on the external storage portion of the logical volume. The SS Storage Client Manager 520 is cognizant of which enabled client machine is accessing the storage subsystem and tags commands in such a way as to ensure correct response return. The SS Storage Client Manager 520 translates specific client requests into actions for a specific logical storage subsystem volume(s) and passes requests on to a SS Storage Volume Manager 540, or to a SS Administration 530. In this example, since the request is a simple read/write for a valid address, there are no triggers for any sort of expansion operation (see below); the command passes along to the SS Volume Manager 540. The SS Volume Manager 540 may be a fairly standard volume manager process. It knows how to take the logical volume commands from the client SAL Virtual Volume Manager (430 in FIG. 4) and translate into appropriate commands for specific drive(s). The SS Volume Manager 540 process handles any logical drive constructs (Mirrors, RAID, etc . . . ) implemented within the External Storage Subsystem 16. The SS Volume Manager 540 then passes along the command to the SS Disk Driver Connection 560 that, in turn, passes the command to the Disk Driver 370 for issuance to the actual drive. A read command returns data from the drive (along with other appropriate responses) to the client, while a write command would send data to the drive (again, ensuring appropriate response back to the initiating client). Ensuring that the request is sent back to the correct client is the responsibility of the SS Client Manager process 520. The SS Administration 530 handles any administrative requests for initialization and setup. The SS Administration process 530 may have a user interface (a Graphical User Interface, or a command line interface) in addition to several internal software automation processes to control operation. The SS Administration process 530 knows how to recognize and report state changes (added/removed drives) to appropriate clients and handles expansion, or contraction, of any particular client's assigned storage area. Any access made to a client's reserved storage area is a trigger for the SS Administration process 530 that more storage space is required. If un-allocated space exists this will be added to the particular client's pool (with the appropriate External Storage Subsystem 16 and HSOA enabled client tables updated).

The same, or very similar, administrative processes are used to transparently add storage to the External Storage Subsystem 16. When an additional storage element is added the SS Administration process 530 recognizes this. The SS Administration process 530 then adds this to the available storage pool (un-reserved and un-allocated), communicates this to the SAL Administration processes 440 and all enabled clients may see the expanded storage.

An External Storage Subsystem 16 may be enabled with the entire SS process stack or an existing intelligent subsystem may only add the SS Network Driver Connection 510, SS Client Manager 520 and SS Administration 530 processes in conjunction with a standard volume manager (et al). In this way the current invention can be used with an existing intelligent storage subsystem or one can be built with all of the processes outlined above.

Operation of Invention—Expansion and Data Sharing

The third aspect of the current invention incorporates the ability for multiple information appliances to share data areas on shared storage devices or pools. In both of the previous examples, each of the HSOA enabled clients treated their logical volumes as their own private storage. No enabled client could see nor access the data or data area of any other enabled client. In these previous examples storage devices may be shared, but data is private. Enabling a sharing of data and storage is a critical element in any truly networked environment. This allows data created, or captured, on one client, or information appliance to be utilized on another within the same networked environment.

Currently, a typically deployed intelligent computing system utilizes a network file system tool (NFS or CIFS are most common) to facilitate the attachment and sharing of external storage. Many issues (see BACKGROUND OF THE INVENTION) arise with this mechanism. Even though the storage subsystem, and even some data, is shared, it's neither easily expandable nor manageable. In all cases the added storage is recognized as a separate drive element or mount point and must be managed separately.

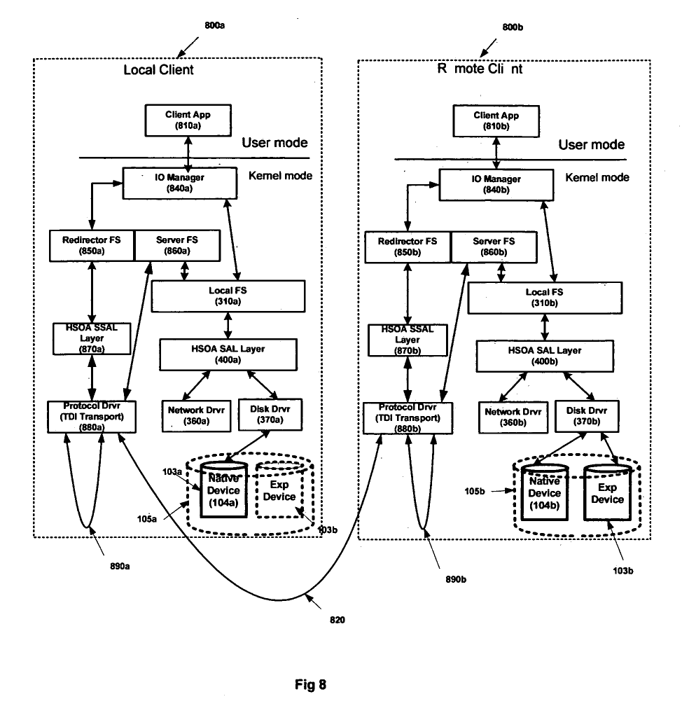

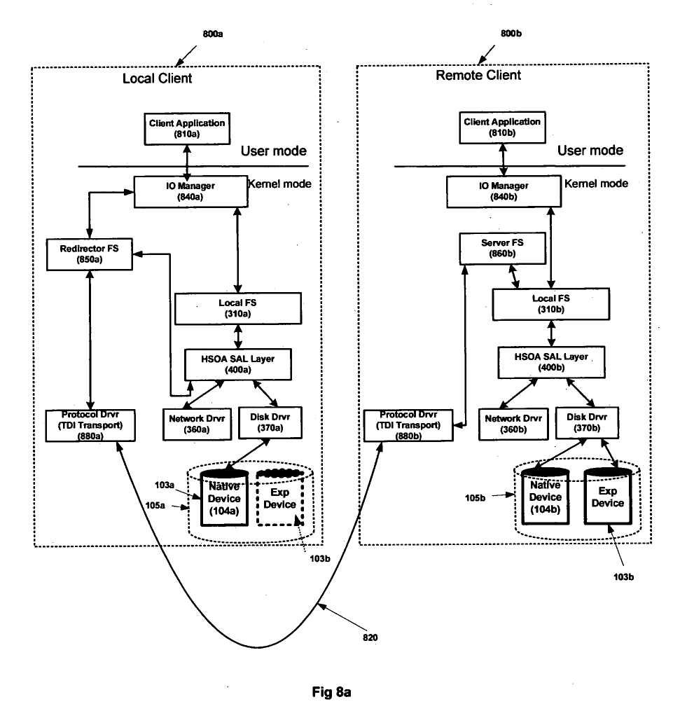

FIGS. 4, 4b and 8 are utilized to illustrate an embodiment of a true, shared storage and data environment wherein the previously described aspects of transparent expansion of an existing native drive are achieved. This example environment contains a pair of information appliances, the local client 800a and the remote client 800b. FIG. 8 differs from FIGS. 3a and 4 in that the simple, single File System (310 in FIGS. 3a and 4) has been expanded. The Local FS 310a, 310b in FIG. 8 is equivalent to the File System 310 in these previous figures. In addition to the Local FS 310a, 310b a pair of new file systems (or file system access drivers) 850a, 860a, 850b, 860b have been added, along with an IO Manager 840a, 840b. These represent examples of native system components commonly found on platforms that support CIFS. The IO Manager 840a, 840b directs Client App 810a, 810b requests to the Redirector FS 850a, 850b or to the Local FS 310a, 310b, depending upon the desired access of the application or user request; local device or remotely mounted device The Redirector FS is used to access a shared storage device (typically remote, but not required) and works in conjunction with the Server FS 860a, 860b to handle locking and other aspects required to share data amongst multiple clients. In systems without the HSOA enabled clients the Redirector FS communicates with the Server FS through a Network File Sharing protocol (e.g. NFS or CIFS). This communication is represented by the Protocol Drvr 880a, 880b and the bi-directional links 820, 890a and 890b. In this way a remote device may be mounted on a local client system, as a separate storage element, and data are shared between the two clients. In this embodiment the HSOA SAL Layer (as described in the previous sections) is again inserted between the Local FS 310a, 310b and the drivers (Network 360a, 360b and Disk 370a, 370b). In addition, a new software process is added. This is the HSOA Shared SAL (SSAL) 870a, 870b and it is layered between the Redirector FS 850a, 850b and the Protocol Drvr 880a, 880b.

For this example a single disk device 103b is directly (or indirectly) added to the remote client 800b. Directly added means an internal disk, such as an IDE disk added to an internal cable, indirectly added means an external disk, such as a USB attached disk. Further, for this example, the device 103b, and any data contained on it are to be shared amongst both clients' 800a, 800b. Thus thru the methods and processes of the current invention the Local Client 800a sees an expanded, logical drive 105a which has a capacity equivalent to its Native Device 104a+the remote Exp Device 103b. In addition, the contents of the expanded, logical drive 105a that reside on Native Device 104a are private (can be written and read only by the local client 800a) while the contents of the expanded, logical drive 105a that reside on Exp Drive 103b are shared (can be read/written by both the Local Client 800a and the Remote Client 800b). Finally the Remote Client 800b also sees an expanded, logical drive 105b which has a capacity equivalent to its Native Device 104b+the local Exp Device 103b. In addition, the contents of the expanded, logical drive 105b that reside on Native Device 104b are private (can be written and read only by the local client 800b) while the contents of the expanded, logical drive 105b that reside on Exp Drive 103b are shared (can be read/written by both the Local Client 800a and the Remote Client 800b). Recall that one of the parameters of this example is that the data on Exp Device 103b are sharable. Thus each client 800a, 800b has private access to its original native storage device 104a, 104b contents and shared access to the Exp Device 103b contents. Although neither client 800a, 800b has any capability to deconstruct its particular expanded drive 105a, 105b.

In this aspect of the current invention the SAL Administration processes 440 (FIG. 4) of each of the client systems has an added capability. They are able to communicate with each other (an extension of previously describe initialization and configuration steps) through the Network Dvr Connection (460 in FIG. 4). When the Expansion Drive 103b is added into Remote Client 800b the SAL Administration process (440 in FIG. 4) local to that SAL Layer 310b does several things upon recognition of the new device. First, it masks recognition of the device from the system (as described in previous examples above). Second, it queries the device for its specific parameters (e.g. type, size, . . .). Third, through either defaults, or user interaction/command it determines if this device 103b is shared or private (or some aspects of both). If it's private, then the device 103b is treated as a normal HSOA added device and expansion of the Native Device 104b into the logical device 105b is accomplished as described above (refer to the section—OPERATION OF INVENTION—BASIC STORAGE EXPANSION). And, no part of the drive would be available to Local Client 800a for expansion. If the Expansion Device 103b is to be shared, the SAL Administration process (440 in FIG. 4) local to that SAL Layer 310b will take the following steps:

(1) An expanded, logical device 105b is created (see OPERATION OF INVENTION BASIC STORAGE EXPANSION section for details on creation of this expanded logical device) as a combination of the Native Device 104b and the Exp Device 103b. Since the Native Device 104b is already known to the LOCAL FS 310b, and the expanded device 105b is simply an expansion, the IO Manager 840b is set to forward any accesses to the Local FS 310b

(2) The availability of the Exp Device 103b and the new logical device 105b are broadcast such that any other HSOA Admin layer (in this case the SAL Administration process (440 in FIG. 4) associated with HSOA SAL Layer 400a) is notified of the existence of the Exp Device 103b, and the new logical device 105b along with their access paths and specific parameters. This can be accomplished through use of a mechanism like the Universal Plug and Play (UPnP) or some other communication mechanism between the various HSOA Admin processes.

(3) The HSOA Virtual Volume table(s) (431 in FIG. 4) associated with SAL Layer 310b is set to indicate that any remote access to addresses ranges corresponding to the Native Device 104b are blocked (i.e. are kept private), while any remote access to addresses ranges corresponding to the Exp Device 103b are allowed.

In addition, the SAL Administration process (440 in FIG. 4) local to that SAL Layer 310a will take the following steps:

(1) An expanded, logical device 105a is created (see OPERATION OF INVENTION BASIC STORAGE EXPANSION section for details on creation of this expanded logical device) as a combination of the Native Device 104a and the remote Exp Device 103b.

(2) The IO Manager 840a in the Local Client 800a is set to recognize the expanded logical device 105a and to forward any accesses via the Redirector FS 850a and not the Local FS 310a. The now-expanded volume appears to be a network attached device, no longer a local device. Note, the Local FS 310a remains aware of this logical device 105a to facilitate accesses via the Server FS 860a, it's simply that all requests are forced through the Redirector 850a and Server FS 860a path.

(3) The HSOA Virtual Volume table(s) (431 in FIG. 4) associated with SAL Layer 400a are set to indicate that any remote access to addresses ranges corresponding to the Native Device 104a are blocked, while any remote access to addresses ranges corresponding to the Exp Device 103b are allowed. Note, this is simply a precaution as any “remote” access to Exp Device 103b would be directed to the Local FS 310b by the 10 Manager 840b and not across to the Local Client 800a.

(4) The HSOA SSAL layer 870a is set to map accesses to addresses ranges, file handles, volume labels or any combination thereof corresponding to the Native Device 104a to the local Server FS 860a with logical drive parameters matching 105a, while any access to addresses ranges, file handles, volume labels or any combination thereof corresponding to the Exp Device 103b are mapped to the remote Server FS 860b with logical drive parameters matching 105b. In this way the various logical drive 105a accesses are mapped to drives recognized by the corresponding Local FS 310a, 310b and HSOA SAL Layer 400a, 400b.

Any and all subsequent accesses (e.g. reads and writes) to the Local Client's 800a logical drive 105a are sent (by the IO Manager 840a) to the Redirector FS 850a. The Redirector FS 850a packages this request for what it believes to be a shared network drive. The Redirector FS 850a works in conjunction with the Sever FS 860a, 860b to handle the appropriate file locking mechanisms which allow shared access. Communication between Redirector FS 850a and Server FS 860a, 860b are done via the Protocol Drvrs 880a, 880b. Commands sent to the Protocol Drvr 880a are filtered by the HSOA SSAL processes 870a. The HSOA SSAL 870a processes are diagramed in FIG. 4b. The SSAL File System Intf 872 intercepts any communication intended for the Protocol Drvr 870a and packages it for use by the SSAL Access Director 874. By re-packaging, as needed, the SSAL File System Intf 872 allows the HSOA SSAL processes 870 to be used with a variant of redirector/server FS types (e.g. Windows, Unix, Linux). The SSAL Access Director 874 utilizes its Access Director table (SSAL AD Table 876) to steer the access to the appropriate Server FS 860a, 860b. This is done by inspecting the block address, file handle, volume label or a combination thereof in the access request to determine if the access is intended for the local Native Device 104a or the remote Exp Device 103b. Once this determination has been made the request is updated as follows:

The IP address of the appropriate Server FS (Local Client 800a or Remote Client 800b) is inserted. This ensures that the command is sent to the correct client.

The Volume label, file handle, block address or a combination thereof are updated to reflect the actual Local FS 310a, 310b aware volume parameters:

If an access is intended for the logical volume 105a as a whole (e.g. some form of volume query) then the access is pointed to logical volume 105a through the local Sever FS 860a

If an access is intended to read/write (or in some way modify data or content) the physical Native Device 104a then the access is pointed to logical volume 105a through the local Sever FS 860a

If an access is intended to read/write (or in some way modify data or content) the physical Exp Device 103b then the access is pointed to logical volume 105b through the Remote Client 800b Sever FS 860b

Once these basic parameters have been established the access request, or command is passed to the Protocol Drvr 880a through the Protocol Drvr Connection 878. The Protocol Drvr Connection 878 allows the allows the HSOA SSAL processes 870 to be used with a variant of redirector/server FS types (e.g. Windows, Unix, Linux) as well as a variant of Network File access protocols (e.g. CIFS and NFS). Accesses through the Sever FS 860a, 860b and the Local FS 310a, 310b are dictated by normal OS operations and access to the actual devices are outlined in the above section (see OPERATION OF INVENTION—BASIC STORAGE EXPANSION). Upon return through the Protocol Drvr 880a, the Protocol Drvr Connection 878 will intercept, and package the request response for the SSAL Access Director 874. The SSAL Access Director 874 reformats the response to align with the original request parameters and passes the response back to the Redirector FS 850a through the SSAL File System Intf 872.

An alternative embodiment is illustrated using FIGS. 4c and 8a This example environment contains a pair of information appliances, the local client 800a and the remote client 800b. For simplified discussion and diagram purposes the Local Client 800a can mount a remote volume served by Remote Client 800b. In everyday practice both the Local Client 800a and the Remote Client 800b can mount logical volumes on one another, and thus both can be servers to the other, and both can have the Redirector and Server methods.

In comparison with FIG. 3a, FIG. 8a shows typical information appliance methods. The Client Application 810a, 810b executing in a non-privileged “user mode” makes file requests of the IO Manager 840a, 840b running in privileged “Kernel mode.” The IO Manger 840a, 840b directs a file request to either a Local File System 310a, 310b, or in the case of a request to a remotely mounted device, to the Redirector FS 850a. The Redirector FS 850a is a standard network file system protocol to facilitate the attachment and sharing of remote storage. The Redirector FS 850a communicates with the remote Server FS 860b through a Network File Sharing protocol (e.g. NFS or CIFS). This communication is represented by the Protocol Drvr 880a, 880b and the bidirectional link 820. In this way a remote device may be mounted on a local client system as a separate storage element, and data are shared between the two clients.

In this embodiment an HSOA SAL Layer 400a, FIG. 4c, (as described in the previous sections) is again inserted between the Local FS 310a, 310b and the drivers (Network 360a, 360b and Disk 370a, 370b). In this aspect of the invention, the HSOA SAL Layer 400a has an additional component, the Redirector Connection 490. This allows the SAL Access Director 450, FIG. 4c, the added option of sending a request to the Redirector Driver 391.

For this example a single disk device 103b is directly (or indirectly) added to the remote client 800b. Directly added means an internal disk, such as an IDE disk added to an internal cable, indirectly added means an external disk, such as a USB attached disk. Further, for this example, the device 103b, and any data contained on it are to be shared amongst both clients' 800a, 800b. Thus thru the methods and processes of the current invention the Local Client 800a sees an expanded, logical drive 105a which has a capacity equivalent to its Native Device 104a+the remote Exp Device 103b. In addition, the contents of the expanded, logical drive 105a that reside on Native Device 104a are private (can be written and read only by the local client 800a) while the contents of the expanded, logical drive 105a that reside on Exp Drive 103b are shared (can be read/written by both the Local Client 800a and the Remote Client 800b). The Remote Client 800b also sees an expanded, logical drive 105b which has a capacity equivalent to its Native Device 104b+the local Exp Device 103b. In addition, the contents of the expanded, logical drive 105b that reside on Native Device 104b are private (can be written and read only by the local client 800b) while the contents of the expanded, logical drive 105b that reside on Exp Drive 103b are shared (can be read/written by both the Local Client 800a and the Remote Client 800b). Recall that a parameter of this example is that the data on Exp Device 103b are sharable. Thus each client 800a, 800b has private access to its original native storage device 104a, 104b contents and shared access to the Exp Device 103b contents. Although neither client 800a, 800b has any capability to deconstruct its particular expanded drive 105a, 105b, in keeping with the basic methods of the current invention.

In this aspect of the current invention the SAL Administration processes 440 (FIG. 4c) of each of the client systems has an added capability. They are able to communicate with each other (an extension of previously describe initialization and configuration steps) through the Network Dvr Connection (460 in FIG. 4c). When the Expansion Drive 103b is added into Remote Client 800b the SAL Administration process (440 in FIG. 4c) local to that SAL Layer 310b does several things upon recognition of the new device. First, it masks recognition of the device from the system (as described in previous examples above). Second, it queries the device for its specific parameters (e.g. type, size, . . .). Third, through either defaults, or user interaction/command it determines if this device 103b is shared or private (or some aspects of both). If it is private, then the device 103b is treated as a normal HSOA added device and expansion of the Native Device 104b into the logical device 105b is accomplished as described above (refer to the section—OPERATION OF INVENTION—BASIC STORAGE EXPANSION). And, no part of the drive would be available to Local Client 800a for expansion. If the Expansion Device 103b is to be shared, the SAL Administration process (440 in FIG. 4c) local to that SAL Layer 310b takes the following steps:

(4) An expanded, logical device 105b is created (see OPERATION OF INVENTION BASIC STORAGE EXPANSION section for details on creation of this expanded logical device) as a combination of the Native Device 104b and the Exp Device 103b.

(5) The availability of the shared Exp Device 103b and parameters about the new logical device 105b are broadcast such that they are received any other HSOA Admin layer (in this case the SAL Administration process (440 in FIG. 4c) associated with HSOA SAL Layer 400a). Notification information includes the existence of the Exp Device 103b, and the new logical device 105b along with their access paths (IP address for example and any other specific identifier) and specific parameters, such as private address ranges on the newly expanded remote device 105a. This is accomplished through use of a mechanism like the Universal Plug and Play (UPnP) or some other communication mechanism between the various HSOA Admin processes.

(6) The HSOA Virtual Volume table(s) (431 in FIG. 4c) associated with SAL Layer 310b is set to indicate that any remote access to addresses ranges corresponding to the Native Device 104b are blocked (i.e. are kept private), while any remote access to addresses ranges corresponding to the Exp Device 103b are allowed.

On the Local Client 800a, the SAL Administration process (440 in FIG. 4c) local to that SAL Layer 310a takes the following steps:

(5) An expanded, logical device 105a is created (see OPERATION OF INVENTION BASIC STORAGE EXPANSION section for details on creation of this expanded logical device) as a combination of the Native Device 104a and the remote Exp Device 103b.

(6) The HSOA Virtual Volume table(s) (431 in FIG. 4c) associated with SAL Layer 400a are set to indicate that any access from a remote client to addresses ranges corresponding to the Native Device 104a are blocked, while any remote access to addresses ranges corresponding to the Exp Device 103b are allowed. This keeps 104a contents private.

(7) The HSOA Virtual Volume table(s) (431 in FIG. 4c) associated with SAL Layer 400a are set to indicate that any access to addresses corresponding to Exp Device 103b are sent out the Redirector Connection 490 and on to the Redirector Driver 391.

A file request from the Client Application 810a proceeds to the 10 Manager 840a, which can choose to send it directly to the Redirector FS 850a if the destination device is remotely mounted directly to the information appliance. Or, the 10 Manager can choose to send the request to the Local FS 310a. In our example the request goes to the Local FS 310a, and is destined for an expanded device 105a. The SAL Access Director 450 (FIG. 4c), which resides within the HSOA SAL Layer 400a processes, determines the path of the request. If the accessed address is on the original native Device 104a the request proceeds to the Disk Drvr 370a.

If the accessed address is on Exp Device 103b, the SAL Access Director 450 adjusts the address, using its knowledge of the remote expanded volume 105b, so that the address accounts for the size of the remote Native Device 104b. (Recall that information on the expanded device 105b was relayed when it was created.) The SAL Access Director 450a then routes the request to the Redirector Connection 490 (FIG. 4c), which forms the request, specifying a return path to the Redirector Connection 490 and passes the request to the Redirector Driver 391, which in turns passes the request to the Redirector FS 850a. The request is sent by the standard system Redirector FS 850a through the Protocol Drvr 880a, across the communication path to the Remote Client 800b Protocol Driver 880b. (There are standard network connections and interactions as used by the protocol implied by the Protocol Drvr 880a.) The Server FS 860a on the Remote Client 800b get the request and performs any file lock checking. The Server FS 860a then passes the request on to the Local FS 310b, which accesses its expanded device 105b through the HSOA SAL Layer 400b. The data are accessed and returned via the reverse path and returned to the Redirector Connection 490 (FIG. 4c) within the Local Client 800a HSOA SAL layer. The return path goes from the HSOA SAL Layer 400a back through the Local FS 310a, the IO Manger 840a, and to the Client Application 810a. By routing the access to the standard Redirector FS 850a, and using a standard file system protocol, file-locking mechanisms are inherent when accessing the data on the Exp Device 103b.

The above descriptions outline how new, logical volumes are created (again, masking the underlying physical devices and simply, transparently presenting larger logical devices to the file systems) and data within them can be shared amongst multiple clients. This differs from current mechanisms were the Exp Device 103b would be mounted and visible on both Clients, but separate from the Native devices 104a, 104b.

Operation of Invention —Client-Attached Storage Element Sharing

The fourth aspect of the current invention is the ability of one client to utilize storage attached to another client. (This is storage element sharing, but not data sharing.) Such attached storage may be internal, such as a storage element attached to an internal cable. Or, the attached storage may be externally attached; such as a wireless connection, a Firewire connection, or a network connection. FIGS. 3 and 4a demonstrate the methods of this aspect of the current invention. While extensible to any attached storage element, this example uses Hub 13 and Chassis 2 100b (FIG. 3). In this example Hub 13 is allowed to utilize an Expansion Drive 104b in Chassis 2 100b as additional storage. This is a very real life situation. Many home environments contain both Entertainment Hubs and PCs and the ability to utilize storage of one to expand the storage of another is extremely advantageous. In this aspect of the current invention the SAL Administration processes 440 (FIG. 4a) of each of the client systems (Chassis 2 100b and Hub 13) are able to communicate with each other through the Network Dvr Connection (460 in FIG. 4a). When the Expansion Drive 104b is added into Chassis 100b the SAL Administration process 440 local to Chassis 2 100b again (as described in previous examples above) masks the recognition of this drive from the OS and FS. The SAL Administration process 440 (FIG. 4b) that resides within the SAL Processes 400b in Chassis 100b then broadcasts (over Home Network 15) the fact that another sharable drive is now present in the environment. Any system enabled with the HSOA software can take advantage of this added storage (including the system into which the storage is added). For the Hub 13, usage is identical to that outlined in the previous sections, where externally available network storage accesses are discussed. The SAL Administration process 440, FIG. 4a, (residing within SAL Processes 400c) in the Hub 13 updates its local logical volume table(s) 431 and the steering table 451 such that accesses beyond the boundary of the local native drive element 103c are directed towards the Expansion drive 104b in Chassis 10b. Again, these are the same processes and steps utilized for the external shared storage access and usage model outlined in the previous section (see OPERATION OF INVENTION—BASIC STORAGE EXPANSION). For the Chassis 10b, FIG. 4a is used to illustrate the SAL processes required to share its Exp Drive 104b. The SAL Administration process 440 sets up the Access Director 450 and the Network Driver Connection process 460 to handle incoming storage requests (previous descriptions simply provided the ability for the Access Director 450 to receive requests from its local Virtual Volume Manager 430). In this embodiment of the invention, the Access Director 450 (associated SAL Processes 400b within Chassis 2 100b in FIG. 3) now accepts requests from remote SAL Processes (400c in FIG. 3). The SAL Administration 440 and Access Director 450 act in a manner similar to that described for the SS Administration (530 in FIG. 5) and SS Client Manager (520 in FIG. 5). In fact, one method of implementation is to add a SAL Client Manager process 480 (similar to the SS Client Manager) into the SAL process stack 400, as illustrated in FIG. 4a. While other implementations are certainly possible (including modifying the Access Director 450 and Network Driver Connection 460 to adopt these functions) the focus of this example is as illustrated in FIG. 4a. As shown in FIG. 4a the local Access Director. 450 still has direct paths to the local Disk Driver Connection 470 and Network Driver Connection 460. However, a new path is added wherein the Access Director 450 may now also steer a storage access through a SAL Client Manager 480. Thus the Access Director's 450 steering table 451 can direct an access directly to a local disk, through the Disk Driver Connection 470; to a remote storage element, through the Network Driver Connection 460; or to a shared internal disk through the SAL Client Manager 480. The SAL Administration process 440 is shown with an interface to the SAL Virtual Volume Manager 430, the Access Director 450 and the SAL Client Manager 480. As described previously, the SAL Administration process 440 is responsible for initialization of all the tables and configuration information in the other local processes. In addition, the SAL Administration process 440 is responsible for communicating local storage changes to other HSOA enabled clients (in a manner similar to the SS Administration process, 530 in FIG. 5) and updating the local tables when a change in configuration occurs (locally, or remotely). The SAL Client Manager 480 acts in much the same way as the SS Client Manager (520 in FIG. 5) and described earlier. An access, for the local storage, is received from either the local Access Director 450 (without the intervening Network transport mechanisms) or from the Access Director of a remote SAL Process (400c in FIG. 3), through the Network Driver 360 and Network Driver Connection 460. Again, similar to the description above, the Client Manager 480 is cognizant of which client machine is accessing the storage (and will tag commands in such a way as to ensure correct response return). The Client Manager 480 translates these specific client requests into actions for a specific local disk volume(s) and passes them to the Disk Driver Connection 470 or to the Admin process 440. There is no volume manager process in this example as no intent exists to support complex logical volumes in this example. While this is certainly possible, and a storage volume manager could be added to this concept, this simpler example is provided. Thus the added drive (104b in FIG. 3) can be partitioned in a manner similar to that shown in FIG. 9 and thus shared amongst any HSOA enabled client in the environment.

The advantages of this ability to share access to attached storage devices are many. A few are outlined below:

(1) Other clients 10a, 10b, or Hubs 13 (FIG. 3) in an HSOA enabled environment can quite easily access and share any storage in the environment without modifications to any File System, Utility, Application or OS. All storage in the environment can be treated as part of a common pool, or Object of which all clients may take advantage.

(2) When any enabled client is added to the environment (or an existing client is upgraded with the HSOA software) it can automatically participate and take advantage of all the available storage. This can be handled through use of a mechanism like the Universal Plug and Play (UPNP) or some other communication mechanism between the various HSOA Admin processes

(3) This is not just a “lower cost NAS box for the home”. This starts as simply a storage/object device on the local HAN (Home Area Network) but can expand to wider area connectivity (not necessarily a larger numbers of servers, but wider geographical area in which to address storage—Internet storage backups, or addressable movie vaults, etc.) and thus almost infinite access to data.

Through the various mechanisms and embodiments described above (BASIC STORAGE EXPANSION, EXPANSION AND BASIC STORAGE SHARING, EXPANSION AND DATA SHARING and CLIENT-ATTACHED STORAGE ELEMENT SHARING) a true bridge is provided between Information Appliances (e.g. the Home entertainment center network/equipment and the Home PC network and equipment). What is common to all Information Appliances is the data, and this is what really wants to be shared. In addition, the groundwork is provided to support a truly distributed, commodity based home computing, network and entertainment infrastructure. In this paradigm all physical components have an extremely short useful life. In a matter of months or a few short years the infrastructure is obsolete. The one lasting aspect of the entire model is the data. The data is the only thing that has long-term value and must be retained. By providing a sharable, virtual and external storage concept we provide the ability for a user to retain data while upgrading other infrastructure elements to meet any future needs.

Description and Operation of Alternative Embodiments

FIG. 3c illustrates another possible embodiment of the current invention. In this instance an intelligent External Storage Subsystem 16 is connected 20, 21 and 22 to any enabled HSOA client (one, or more) 100a, 100b, or 13 through a storage interface as opposed to a network interface. In this case the SAL Processes 400a, 400b and 400c utilize a Disk Driver 370a, 370b, and 370c and corresponding standard Disk Interface 372a, 372b, 372c to facilitate connectivity to the intelligent External Storage Subsystem 16. The nature and specific type of standard storage interconnect (e.g. FireWire, USB, SCSI, FC, . . .) is immaterial. Operation of this particular embodiment is similar to that described in the OPERATION OF INVENTION—STORAGE EXPANSION AND BASIC SHARING (see earlier section of this document) and the following description assumes that any relevant aspects of that embodiment are understood and included in this alternative. The differences are illustrated below.

Using FIG. 5a (with FIGS. 3c and 4 referenced when necessary) the operation of this alternative embodiment is summarized. When an external, intelligent storage subsystem is added to a home network with HSOA enabled clients, the SAL Administration process (440 in FIG. 4) of each HSOA enabled client is informed of the additional storage by the system processes. Each HSOA enabled client has its logical volume table (431 in FIG. 4), its steering table (451 in FIG. 4) and its drive configuration table (441 in FIG. 4) updated to reflect the addition of the new storage. The simplest mechanism is to add the new storage as a logical extension of the current storage, and thus any references to storage addresses past the physical end of the current drive are directed to the additional storage. For example, this results in the following. Looking at FIG. 3c, if, prior to addition of the new storage, Client PC Chassis 100a consists of C-Drive 103a with capacity of 15 GBytes and D-Drive 104a with capacity of 20 GBytes; Client PC Chassis 100b consists of C-Drive 103b with capacity of 30 GBytes; and Hub 13 consists of native drive 103c with capacity of 60 GBytes then the addition of External Storage Subsystem 16 with a capacity of 400 GBytes results in the following:

(1) The File System 310a in Chassis 100a sees C-Drive 103a having a capacity of 15+400, or 415 GBytes;

(2) The File System 310a in Chassis 100a sees D-Drive 104a having a capacity of 20+400, or 420 GBytes;

(3) The File System 310b in Chassis 100b sees C-Drive 103b having a capacity of 30+400, or 430 GBytes; and

(4) The File System 310c in Hub 13 sees a native drive 103c having a capacity of 60+400, or 460 GBytes

In the example above we added a TOTAL of 400 GBytes of extra capacity. While each of the HSOA enabled clients can utilize this added capacity, and each of the attached clients new, logical drives appear to grow by the entire 400 GBytes they cannot each, in truth, utilize all 400 GBytes. To do so would imply that we are storing an equivalent of

415+420+430+460=1725 GBytes, or 1.725 TBytes

This is, clearly, more capacity than was added. In actuality the added capacity is spread across all of the native drives in the environment enabled by the methods described in this invention. This method of capacity distribution is clearly not the only possible. There are other algorithms (e.g., a certain portion of the overall added capacity could be assigned to each native drive—not the entire amount) that could be used but they are immaterial to the nature of this invention.

The SAL processes (400a, 400b and 400c in FIG. 3c) are creating these logical drives, or storage objects, but the actual usage of the External Storage Subsystem 16 will be managed by the SSMS processes 500. As part of the discovery and initial configuration process the SAL Administration process (440 in FIG. 4) communicates with the SS Administration process 530. Part of this communication is to negotiate for the initial storage partitioning. As illustrated in FIG. 9 each attached, HSOA enabled client is allocated some initial space (e.g., double space of native drive)

1. Drive element 103a (Chassis 100a C-Drive) is allocated 30 GBytes 910

2. Drive element 104a (Chassis 100a D-Drive) is allocated 40 GBytes 920

3. Drive element 103b (Chassis 100b C-Drive) is allocated 60 GBytes 930

4. Drive element 103c (Hub 13 Native-Drive) is allocated 120 GBytes 940 and some reserved space (typically, 50% of the allocated space)

1. Drive element 103a (Chassis 100a C-Drive) is reserved an additional 15 GBytes

2. Drive element-104a (Chassis 100a D-Drive) is reserved an additional 20 GBytes

3. Drive element 103b (Chassis 100b C-Drive) is reserved an additional 30 GBytes

4. Drive element 103c (Hub 13 Native-Drive) is reserved an additional 60 GBytes by the SS Admistration process 530.

Again, this allocation is only an example. Many alternative allocations are possible and fully supported by this invention.

Details of this allocation are, again, provided earlier in the OPERATION OF INVENTION—STORAGE EXPANSION AND BASIC SHARING section and in Table III (below).

TABLE III
Steering Table - Logical C-Drive

| Logical Address Range | | | Actual/Physical | |
|---|---|---|---|---|
| (word = 4 bytes) | Drive | Interface | Drive Address | Notes/Actions |
| 1-3,750,000,000 | C | Disk0 | 1-3,750,000,000 | Access Native Drive |
| 3,750,000,001-12,500,000,000 | Ext SS | Disk1 | 1-7,500,000,000 | Access External Storage Subsystem |
| 12,500,000,001-15,000,000,000 | Ext SS | Disk1 | 7,500,000,001-11,250,000,000 | Using up the reserved area, have |
| | | | | Administration process increase |
| | | | | reserve space |
| 15,000,000,001-max address | NA | NA | ERROR | Error, has to be handled as an out |
| | | | | of bounds condition |

Once the basic tables are set up (e.g. Table III), HSOA enabled client operations proceed in a manner similar to that described previously. The SAL File System Interface process (420 in FIG. 4) intercepts all storage element requests. These pass on to the SAL Virtual Volume Manager process (430 in FIG. 4) that, through use if its logical volume tables, either responds to the request directly (a volume size query, for example) or passes the request on to the Access Director process (450 in FIG. 4). Requests that pass on to the Access Director 450 imply that the actual device is accessed (typically a read or a write). The Access Director 450, through use of its steering tables (451 in FIG. 4), dissects the logical volume request and determines which physical volume to address and what block address to utilize.

In the case in hand (the environment illustrated in FIG. 3c with the External Storage Subsystem 16, encompassing an additional 400 GBytes of storage capacity, configured as an extension to the internal disk drives 103a, 103b, 103c, and 104a, as outlined above), assume that the client represented by PC chassis 100a is accessing its logical C-drive at address 6,000,000,000 (word address, with a word consisting of 4 bytes). In an actual environment addressing methodologies can vary, these addresses are simply used to convey the mechanisms and processes involved. The SAL Virtual Volume Manager process (430 in FIG. 4) determines that this is a read/write operation for its logical C-drive. This is passed along to the Access Director (450 in FIG. 4). The Access Director 450 utilizes its steering table (451 in FIG. 4, and Table III above) to determine how to handle the request. The logical disk address is used as an index entry into the table (e.g. using the Logical Address Range column in Table III). This will then indicate that the External Storage Subsystem 16 must be accessed, using the Disk Driver (370 in FIG. 4) and Disk Interface 1 (372 in FIG. 4). The table indicates the appropriate driver, if more than one exists, and the adjusted address. In this case a local address 6,000,000,000 maps to remote address of 2,250,000,000. Once this determination is made, the Access Director 450 passes the request to the appropriate connection process, in this case the Disk Driver Connection process (470 in FIG. 4). The connection process then appropriately packages, or encapsulates the request such that it passes to the correct standard Disk Driver (370 in FIG. 4) that, in turn, accesses the device. In this case the device is an intelligent External Storage Subsystem 16 (FIG. 3c) with processes and interfaces illustrated in FIG. 5a. The HSOA enable client request is picked up by the External Storage Subsystem's 16 Disk Interface 580 and Disk Driver 570. These are similar (if not identical) to those of a client system (reference numbers differ from the 370 and 371 sequence to differentiate from other Disk Driver and Interface in FIG. 3). A Storage Subsystem (SS) Disk Driver Connection 515 provides an interface between the standard Disk Driver 570 and a SS Storage Client Manager 520. The SS Disk Driver Connection process 515 is, in part, a mirror image of an enabled client's Disk Driver connection process (410 in FIG. 4). It knows how to pull apart the transported packet to extract the storage request, as well as how to encapsulate responses, or requests, back to an enabled client. In this example the SS Disk Driver Connection 515 extracts the read/write request to address 2,250,000,000 on the external storage portion of the logical volume. The SS Storage Client Manager 520 is cognizant of which enabled client machine is accessing the storage subsystem (and tags commands in such a way as to ensure correct response return. The SS Storage Client Manager 520 translates specific client requests into actions for a specific logical storage subsystem volume(s) and passes requests on to a SS Storage Volume Manager 540, or to a SS Administration 530. In this example, since the request is a simple read/write for a valid address, there are no triggers for any sort of expansion operation; the command passes along to the SS Volume Manager 540. The SS Volume Manager 540 may be a fairly standard volume manager process. It knows how to take the logical volume commands from the client SAL Virtual Volume Manager (430 in FIG. 4) and translate into appropriate commands for specific drive(s). The SS Volume Manager 540 process handles any logical drive constructs (Mirrors, RAID, etc . . .) implemented within the External Storage Subsystem 16. The SS Volume Manager 540 then passes along the command to the SS Disk Driver Connection 560 that, in turn, passes the command to the Disk Driver 370 for issuance to the actual drive. A read command returns data from the drive (along with other appropriate responses) to the client, while a write command would send data to the drive (again, ensuring appropriate response back to the initiating client). Ensuring that the request is sent back to the correct client is the responsibility of the SS Client Manager process 520. The SS Administration 530 handles any administrative requests for initialization and setup.

An External Storage Subsystem 16 may be enabled with this entire SS process stack or an existing intelligent subsystem may only add the SS Disk Driver Connection 515, SS Client Manager 520 and SS Administration 530 processes in conjunction with a standard volume manager (et al). In this way the current invention can be used with an existing intelligent storage subsystem or one can be built with all of the processes outlined above.

### CONCLUSION, RAMIFICATIONS, AND SCOPE OF INVENTION

Thus the reader will see that the Home Shared Object Architecture provides a highly effective and unique environment for:

(1) Easily, and transparently expanding a clients native storage capacity

(2) Allow for multiple clients or machines to utilize a single, common external storage element

While the above description contains many specificities, these should not be construed as limitations on the scope of the invention, but rather as an exemplification of one preferred embodiment thereof. Many other variations are possible. For example:

Don't have to be Windows based PCs; can be MACs, Unix or Linux based servers.

Home network can be implemented in many ways; could be as simple as multiple USB links directly from “enabled client(s)” directly to the intelligent storage device.

Accordingly, the scope of the invention should be determined not by the embodiment(s) illustrated, but by the appended claims and their legal equivalents.

We claim: Method

1. A method for expanding storage capacity of an information appliance having a native first storage element; the method comprising:
placing a second storage element in communication with the information appliance;
determining the storage capacity of the second storage element;
merging at least a portion of the capacity of the second storage element with the capacity of the native first storage element.

2. A method according to claim 1, wherein the merging occurs below a file system layer of the information appliance.

3. A method according to claim 1, wherein the act of merging comprises modifying a logical volume table on the information appliance such that the capacity of the logical volume in the logical volume table is equal to the capacity of the native first storage element plus at least a portion of the capacity of the second storage element.

4. A method according to claim 3, wherein the act of merging further comprises modifying a steering table stored in the information appliance to translate between a logical storage element address and a physical storage element address on the second storage element.

5. A method according to claim 1, wherein the second storage element is selected from the group of second storage elements consisting of a hard disk drive, a network attached storage drive, a floppy drive, a USB drive, a CD-ROM, a CD-RAM, and DVD-ROM, a DVD-RAM, an optical storage device, a magnetic storage device, an electronic solid-state storage device, a flash memory device, a molecular storage device, a tape drive, and combinations thereof.

6. A method according to claim 1 wherein the information appliance is selected from the group of information appliances consisting of a computer, a personal computer, an entertainment hub, a game box, a personal digital assistant, a data or information recorder, a data storage system, a data server, a digital camera, a household appliance, an automobile, a transportation device, a mobile telephone, a communications device, and combinations thereof.

7. A method according to claim 1, further comprising allocating space on the second storage element for storage by the native first storage element.

8. A method according to claim 1, further comprising sharing the second storage element with a second information appliance.

9. A method according to claim 8, wherein the act of sharing comprises merging at least a portion of the capacity of the second storage element with the capacity of a native second storage element on the second information appliance.

10. A method according to claim 1, wherein the second storage element comprises a hard disk drive, a network attached storage drive, a floppy drive, a USB drive, a CD-ROM, a CD-RAM, and DVD-ROM, a DVD-RAM, an optical storage device, a magnetic storage device, an electronic solid-state storage device, a flash memory device, a molecular storage device, a tape drive, and combinations thereof.
System

1. A computing system supporting transparent expansion of storage, the system comprising:
an information appliance;
a plurality of storage elements connected to the information appliance;
a device driver operable to communicate with at least one of the storage elements;
a file system accessible to the information appliance, the file system operable to receive a logical address for a storage request and convert the logical address into a physical address;
a steering table accessible to the information appliance, the steering table associating physical addresses with each of the plurality of second storage elements; and
wherein the information appliance is operable to invoke a process operable to receive the physical address, access the steering table and identify the at least one of the second storage elements and call the device driver.

2. A computing system according to claim 1, the system further comprising:
a logical volume table on the information appliance, the capacity of a logical volume in the logical volume table equal to the capacity of a native first storage element plus at least a portion of the capacity of a second storage element.

3. A system according to claim 1, wherein at least one of the plurality of storage elements is selected from the group of storage elements consisting of a hard disk drive, a network attached storage drive, a floppy drive, a USB drive, a CD-ROM, a CD-RAM, and DVD-ROM, a DVD-RAM, an optical storage device, a magnetic storage device, an electronic solid-state storage device, a flash memory device, a molecular storage device, a tape drive, and combinations thereof.

4. A system according to claim 1, wherein the information appliance is selected from the group of information appliances consisting of a computer, a personal computer, an entertainment hub, a game box, a personal digital assistant, a data or information recorder, a data storage system, a data server, a digital camera, a household appliance, an automobile, a transportation device, a mobile telephone, a communications device, and combinations thereof.

5. A system according to claim 1, further comprising at least a second information appliance in communication with at least one of the plurality of storage devices.
Computer Program Product

1. A computer program product for use in conjunction with an information appliance having at least one processor coupled to native storage and a file system, the computer program product comprising a computer readable storage medium and a computer program mechanism embedded therein, the computer program mechanism comprising:
a program module that directs the information appliance to function in a specified manner to transparently add storage, the program module including instructions for:
recognizing addition of a second storage element;
determining the storage capacity of the second storage element;
merging at least a portion of the capacity of the second storage element with the capacity of the native storage; wherein the merging occurs below the file system layer.

2. A computer program product according to claim 1, wherein the merging occurs below a file system layer of the information appliance.

3. A computer program product according to claim 1, wherein the instructions for merging comprise instructions for modifying a logical volume table on the information appliance such that the capacity of the logical volume in the logical volume table is equal to the capacity of the native first storage element plus at least a portion of the capacity of the second storage element.

4. A computer program product according to claim 3, wherein the instructions for merging further comprise instructions for modifying a steering table stored in the information appliance to translate between a logical storage element address and a physical storage element address on the second storage element.

5. A computer program product according to claim 1, wherein the second storage element is selected from the group of second storage elements consisting of a hard disk drive, a network attached storage drive, a floppy drive, a USB drive, a CD-ROM, a CD-RAM, and DVD-ROM, a DVD-RAM, an optical storage device, a magnetic storage device, an electronic solid-state storage device, a flash memory device, a molecular storage device, a tape drive, and combinations thereof.

6. A computer program product according to claim 1 wherein the information appliance is selected from the group of information appliances consisting of a computer, a personal computer, an entertainment hub, a game box, a personal digital assistant, a data or information recorder, a data storage system, a data server, a digital camera, a household appliance, an automobile, a transportation device, a mobile telephone, a communications device, and combinations thereof.

7. A computer program product according to claim 1, wherein the program module further includes instructions for allocating space on the second storage element for storage by the native first storage element.

8. A computer program product according to claim 1, wherein the program module further includes instructions for sharing the second storage element with a second information appliance.

9. A computer program product according to claim 8, wherein the instructions for sharing comprise instructions for merging at least a portion of the capacity of the second storage element with the capacity of a native second storage element on the second information appliance.

10. A computer program product according to claim 1, wherein the second storage element comprises a drive.

11. A computer program product for use in conjunction with an information appliance having at least one processor and a file system, the computer program product comprising a computer readable storage medium and a computer program mechanism embedded therein, the computer program mechanism comprising:
a program module that directs the information appliance to function in a specified manner to access at least one attached second storage element, the program module including instructions for:
receiving a physical address from a file system;
identifying which of a plurality of attached second storage elements corresponds to the received physical address; and
communicating with a device driver for the identified attached second storage element.

12. A computer program product according to claim 11, the program module further including instructions for:
receiving requested data from the identified attached second storage element.

13. A computer program product according to claim 11, wherein at least one of the attached storage element is selected from the group of second storage elements consisting of a hard disk drive, a network attached storage drive, a floppy drive, a USB drive, a CD-ROM, a CD-RAM, and DVD-ROM, a DVD-RAM, an optical storage device, a magnetic storage device, an electronic solid-state storage device, a flash memory device, a molecular storage device, a tape drive, and combinations thereof.

14. A computer program product according to claim 11 wherein the information appliance is selected from the group of information appliances consisting of a computer, a personal computer, an entertainment hub, a game box, a personal digital assistant, a data or information recorder, a data storage system, a data server, a digital camera, a household appliance, an automobile, a transportation device, a mobile telephone, a communications device, and combinations thereof.
